(19) United States
(12) Patent Application Publication
(10) Pub. No.: US 2018/0341450 A1
(43) Pub. Date: Nov. 29, 2018

(54) MOBILE ELECTRONIC DEVICE

(71) Applicant: KYOCERA Corporation, Kyoto-shi (JP)

(72) Inventor: Toshiaki NADE, Yokohama-shi (JP)

(21) Appl. No.: 15/987,083

(22) Filed: May 23, 2018

(30) Foreign Application Priority Data
May 24, 2017 (JP) 2017-103005
May 25, 2017 (JP) 2017-103792

(51) Int. Cl. G06F 3/14

(52) U.S. Cl. CPC G06F 3/1423; H04M 1/0266

(57) ABSTRACT

A mobile electronic device includes a first display, a second display configured to switch between a transmissive state in which incident light is transmitted and a reflective state in which incident light is reflected, and a controller configured to, when a predetermined event occurs while display is appearing on the first display, allow the second display to display a first image related to the predetermined event until a predetermined operation is detected after the predetermined event occurs, and allow the second display to display a second image not related to occurrence of the predetermined event and then hide the second image after a predetermined time elapses.

### CROSS-REFERENCE TO RELATED APPLICATION(S)

The present application claims priority under 35 U.S.C. § 119 to Japanese Patent Application No. 2017-103005 filed on May 24, 2017, entitled “MOBILE ELECTRONIC DEVICE, CONTROL METHOD, AND CONTROL PROGRAM” and Japanese Patent Application No. 2017-103792 filed on May 25, 2017, entitled “MOBILE ELECTRONIC DEVICE, CONTROL METHOD, AND CONTROL PROGRAM”. The contents of which are incorporated by reference herein in its entirety.

### FIELD

Embodiments of the present disclosure relate to a mobile electronic device.

Some of mobile electronic devices are known to have transmissive-type displays. The mobile electronic device uses a light source such as a backlight to allow a transmissive-type display to be visually recognized.

### SUMMARY

It is an object of the present disclosure to at least partially solve the problems in the conventional technology.

A mobile electronic device according to one aspect includes a first display, a second display configured to switch between a transmissive state in which incident light is transmitted and a reflective state in which incident light is reflected, and a controller configured to, when a predetermined event occurs while display is appearing on the first display, allow the second display to display a first image related to the predetermined event until a predetermined operation is detected after the predetermined event occurs, and allow the second display to display a second image not related to occurrence of the predetermined event and then hide the second image after a predetermined time elapses.

A mobile electronic device according to one aspect includes a display configured to switch between a transmissive state in which incident light is transmitted and a reflective state in which incident light is reflected, and a controller configured to allow the display to display a first image related to a predetermined event until a predetermined operation is detected after the predetermined event occurs and allow the display to display a second image not related to occurrence of the predetermined event and then hide the second image after a predetermined time elapses.

A mobile electronic device according to one aspect includes a first display, an operation part disposed at a position not overlapping at least the first display, and a second display having a display region overlapping at least the operation part, the second display being configured to switch between a transmissive state in which incident light is transmitted and a reflective state in which incident light is reflected.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a front view illustrating an example of a smartphone according to embodiments;

FIG. 2 is a diagram illustrating an example of arrangement of displays of the smartphone according to embodiments;

FIG. 3 is a rear view of an example of the smartphone according to embodiments;

FIG. 4 is a diagram illustrating an example of arrangement on the back-face side of the smartphone according to embodiments;

FIG. 5 is a diagram illustrating an example of a state of a second display according to embodiments;

FIG. 6 is a diagram illustrating an example of display regions of a first display and the second display according to embodiments;

FIG. 7 is a block diagram of the smartphone according to embodiments;

FIG. 8 is a diagram illustrating an example of display control performed by the smartphone according to embodiments;

FIG. 9 is a diagram illustrating another example of display control performed by the smartphone according to embodiments;

FIG. 10 is a flowchart illustrating the procedure of an example of display control performed by the smartphone according to embodiments;

FIG. 11 is a diagram illustrating another example of display control performed by the smartphone according to embodiments;

FIG. 12 is a diagram illustrating another example of display control performed by the smartphone according to embodiments;

FIG. 13 is a diagram illustrating another example of display control performed by the smartphone according to embodiments;

FIG. 14 is a diagram illustrating another example of a second display region of the second display;

FIG. 15 is an example of a front view of the smartphone according to embodiments;

FIG. 16 is a diagram schematically illustrating a cross section taken along line I-I in FIG. 15 according to embodiments;

FIG. 17 is a block diagram illustrating an example of the functional configuration of the smartphone according to embodiments;

FIG. 18 is a schematic diagram illustrating an example of the display principle of the second display according to embodiments;

FIG. 19 is a diagram illustrating an example of a display control table according to embodiments;

FIG. 20 is a diagram illustrating an example of first image configuration data according to embodiments;

FIG. 21 is a diagram illustrating an example of second image configuration data according to embodiments;

FIG. 22 is a diagram illustrating an example of the display method by the smartphone according to embodiments;

FIG. 23 is a diagram illustrating an example of the display method by the smartphone according to embodiments;

FIG. 24 is a flowchart illustrating an example of the process executed by the smartphone according to embodiments;

FIG. 25 is an example of a front view of the smartphone according to embodiments;

FIG. 26 is a diagram schematically illustrating a cross section taken along line II-II in FIG. 25 according to embodiments;

FIG. 27 is a diagram illustrating an example of second configuration image data according to embodiments;

FIG. 28 is a diagram illustrating an example of the display method by the smartphone according to embodiments;

FIG. 29 is an example of a front view of the smartphone according to embodiments;

FIG. 30 is a schematic diagram illustrating a cross section taken along line III-III in FIG. 29 according to embodiments;

FIG. 31 is another example of the front view of the smartphone according to embodiments;

FIG. 32 is a diagram illustrating a configuration example of a display control table according to embodiments;

FIG. 33 is a diagram illustrating an example of the display method by the smartphone according to embodiments;

FIG. 34 is a diagram illustrating an example of the display method by the smartphone according to embodiments; and

FIG. 35 is a flowchart illustrating an example of a process executed by the smartphone according to embodiments.

### DETAILED DESCRIPTION

Embodiments for implementing a mobile electronic device, a control method, and a control program in accordance with the subject application will be described in detail with reference to the drawings. In the following, a smartphone will be described as an example of the mobile electronic device.

### Embodiments

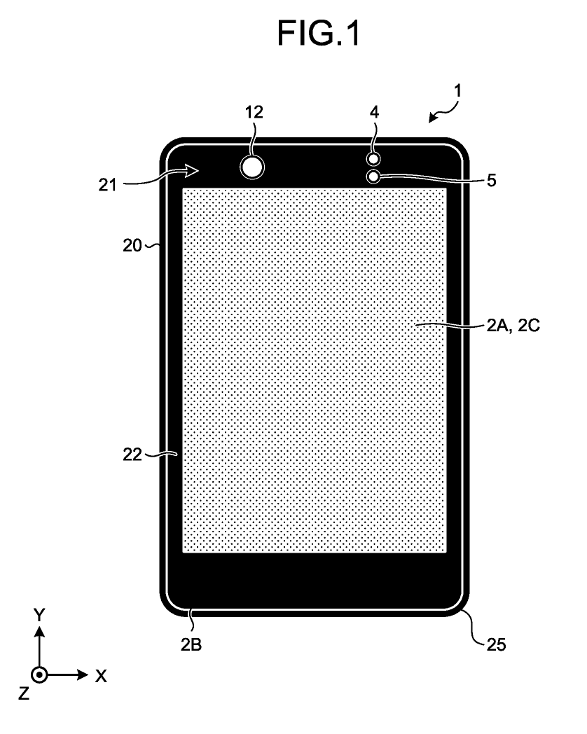

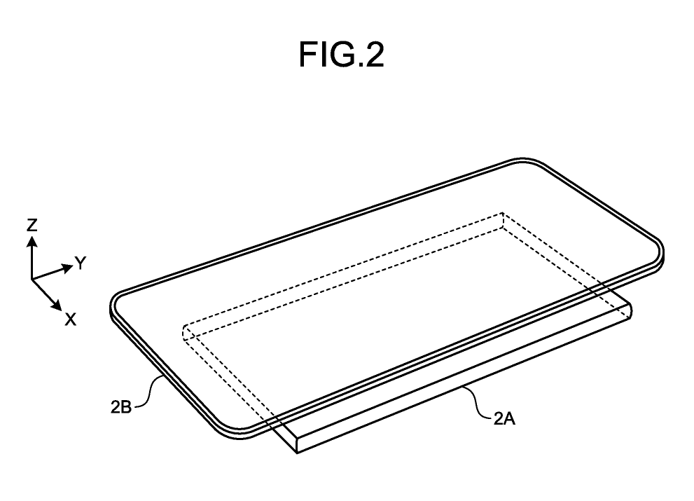

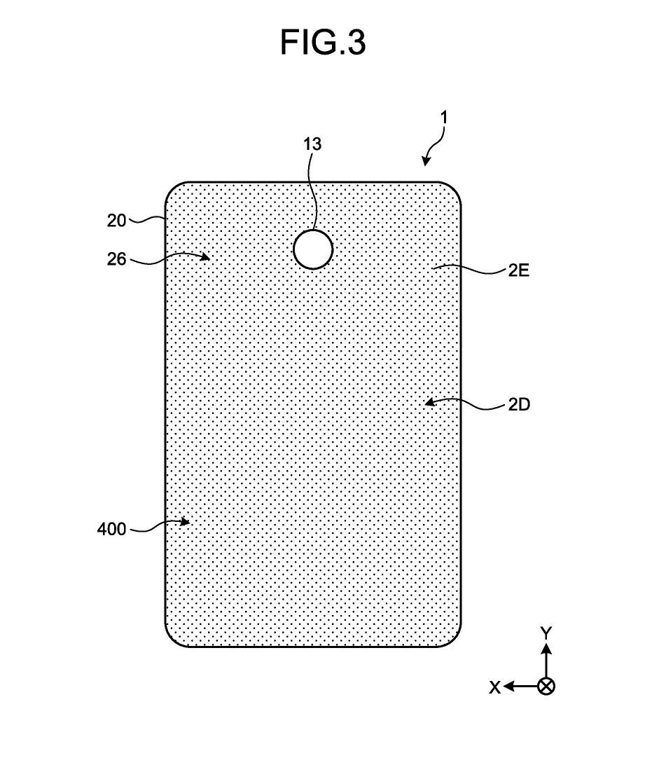

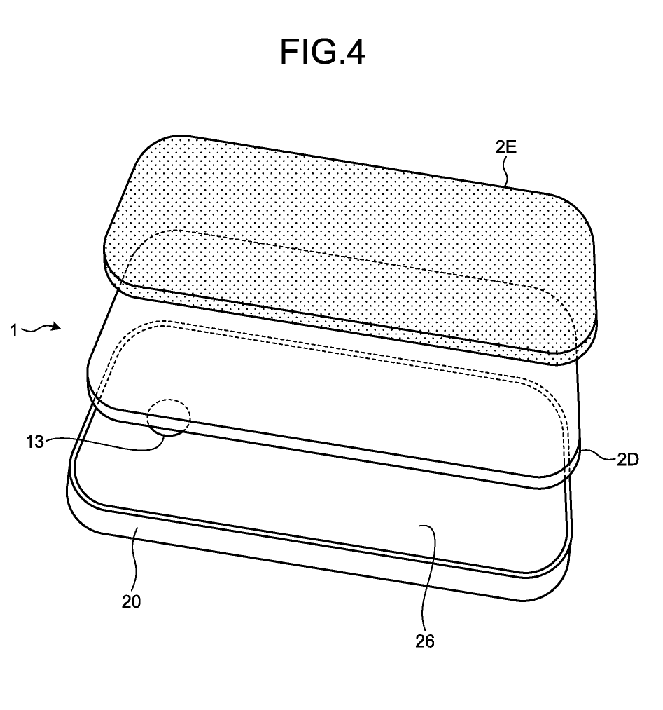

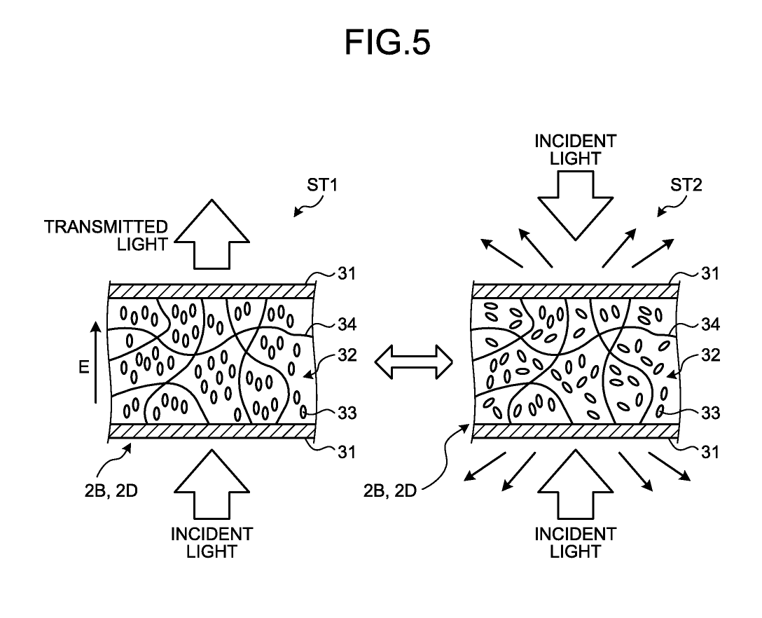

Referring to FIG. 1 to FIG. 5, an overall configuration of a smartphone 1 according to embodiments will be described. FIG. 1 is a front view illustrating an example of the smartphone 1 according to embodiments. FIG. 2 is a diagram illustrating an example of arrangement of displays of the smartphone 1 according to embodiments. FIG. 3 is a rear view of an example of the smartphone 1 according to embodiments. FIG. 4 is a diagram illustrating an example of arrangement on the back-face side of the smartphone 1 according to embodiments. FIG. 5 is a diagram illustrating an example of a state of a second display according to embodiments.

As illustrated in FIG. 1, the smartphone 1 includes a housing 20. The housing 20 has a main face 21 and a back face 26. The main face 21 is a front face of the smartphone 1. The back face 26 is a face opposed to the main face 21 of the smartphone 1. The smartphone 1 has a first display 2A, a second display 2B, a touchscreen 2C, an ambient light sensor 4, a proximity sensor 5, and a camera 12 on the main face 21. The smartphone 1 has a second display 2D, a colored member 2E, and a camera 13 on the back face 26.

The first display 2A and the touchscreen 2C have a substantially rectangular shape along the periphery of the main face 21. The first display 2A and the touchscreen 2C are surrounded by a front panel 22 of the housing 20 on the main face 21. Although the first display 2A and the touchscreen 2C each have a substantially rectangular shape, the shape of the first display 2A and the touchscreen 2C is not limited thereto. The first display 2A and the touchscreen 2C each may have any shape, such as a square or a circle. Although in the example in FIG. 1, the first display 2A and the touchscreen 2C are positioned to overlap each other, the position of the first display 2A and the touchscreen 2C is not limited thereto. The first display 2A and the touchscreen 2C may be, for example, positioned side by side or positioned at a distance from each other. In the example in FIG. 1, the long side of the first display 2A extends along the long side of the touchscreen 2C, and the short side of the first display 2A extends along the short side of the touchscreen 2C. However, the manner of overlapping of the first display 2A and the touchscreen 2C is not limited thereto. When the first display 2A and the touchscreen 2C are positioned to overlap each other, for example, one or more sides of the first display 2A may not extend along any sides of the touchscreen 2C.

The first display 2A includes a display device, such as a liquid crystal display (LCD), an organic electro-luminescence display (OELD), or an inorganic electro-luminescence display (IELD). The first display 2A includes a transmissive-type display or a light emitting-type display. In embodiments described here, the first display 2A is a liquid crystal display having a backlight.

The second display 2B has a shape similar to the shape of the main face 21 of the housing 20 as illustrated in FIG. 1. The second display 2B has a shape larger than the first display 2A. The second display 2B is superimposed on the first display 2A and the entire surface of the front panel 22 of the housing 20. The second display 2B has its entire surface covered with a toughened glass 25. The second display 2B is sandwiched between the first display 2A and the toughened glass 25. The second display 2B may be laminated between the first display 2A and the toughened glass 25, for example, with photocurable resin, adhesive, or the like.

The second display 2D has a shape similar to the shape of the back face 26 of the housing 20, as illustrated in FIG. 3 and FIG. 4. The second display 2D is superimposed on the entire back face 26 of the housing 20. The second display 2D has its entire surface covered with a light-transmitting colored member 2E. The second display 2D is sandwiched between the back face 26 of the housing 20 and the colored member 2E. Although the second display 2D is covered with the colored member 2E in embodiments described here, it may be covered with a toughened glass 25 in the same manner as in the second display 2B.

The second displays 2B and 2D include a polymer network liquid crystal (PNLC), electronic paper, or the like. In embodiments described here, the second displays 2B and 2D are polymer network liquid crystal displays.

As illustrated in FIG. 5, the second displays 2B and 2D each include substrates 31 of glass or transparent films (for example, made of an organic material) and a liquid crystal layer 32. The second displays 2B and 2D have a transmissive state ST1 in which incident light is transmitted and a reflective state ST2 in which incident light is reflected.

The transmissive state ST1 is a state in which a voltage is applied between the substrates 31 of the second displays 2B and 2D. When the second displays 2B and 2D are in the transmissive state ST1, application of a voltage allows liquid crystal molecules 33 to be aligned in the electric field direction E and brings about a transparent state. In the transmissive state ST1, the second displays 2B and 2D allow incident light to pass through. In the transmissive state ST1, the second displays 2B and 2D allow the incident light from the outside of the substrate 31 to be emitted as transmitted light from the substrate 31 on the opposite side. In the transmissive state ST1, the second displays 2B and 2D do not scatter incident light and are transparent. In the transmissive state ST1, the second display 2B can allow the user to visually recognize the first display 2A, the front panel 22, and the like behind. In the transmissive state ST1, the second display 2D can allow the user to visually recognize the back face 26 of the housing 20, the camera 13, and the like behind. The transmissive state ST1 includes a state in which the user can visually recognize behind the second displays 2B and 2D through the second displays 2B and 2D. The transmissive state ST1 may include a translucent state.

The reflective state ST2 is a state in which a voltage is not applied between the substrates 31 of the second displays 2B and 2D. In the reflective state ST2 of the second displays 2B and 2D, the mesh-like polymer network 34 inside the liquid crystal layer 32 acts to induce an irregularly oriented state of the liquid crystal molecules 33 to cause light to be reflected or scattered. The second displays 2B and 2D in the reflective state ST2 can develop an opaque state because of reflection and scattering of light by the liquid crystal molecules 33. In the reflective state ST2, the second displays 2B and 2D can allow the user to visually recognize an opaque part of the second display 2B with reflected or scattered light. The second display 2B can hide the first display 2A, the front panel 22, and the like behind under the opaque part in the reflective state ST2. The second display 2D can hide the back face 26 of the housing 20, the camera 13, and the like behind under the opaque part in the reflective state ST2.

The development of the transmissive state ST1 and the reflective state ST2 in the presence/absence of voltage application means being switchable by the presence/absence of voltage application, and it is not intended that application of a voltage itself uniquely limits the transmissive state ST1. That is, in the example described above, the second displays 2B and 2D enter a transparent state by application of a voltage. However, a reverse configuration may be employed, in which the second displays 2B and 2D enter the transmissive state ST1 in a state in which a voltage is not applied and enter the reflective state ST2 in a state in which a voltage is applied. In the following description, it is assumed that the second displays 2B and 2D enter the transmissive state ST1 in a state in which a voltage is applied between the substrates 31, and the second displays 2B and 2D enter the reflective state ST2 in a state in which a voltage is not applied between the substrates 31.

In embodiments described here, the second displays 2B and 2D allow light outside of the smartphone 1 to be reflected or scattered by the liquid crystal molecules 33, thereby allowing the user to visually recognize the portion in the reflective state ST2 in a cloudy white state. However, the embodiments are not limited thereto. For example, the second displays 2B and 2D may be formed of a material exhibiting a color different from white.

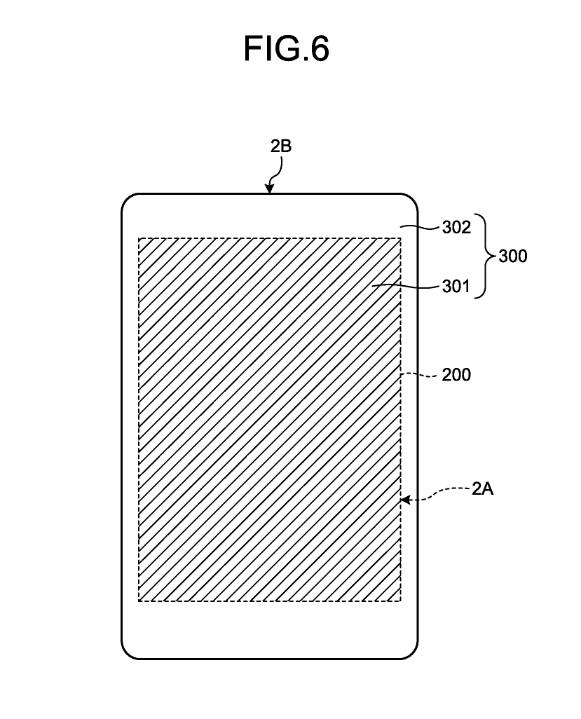

FIG. 6 is a diagram illustrating an example of display regions of the first display 2A and the second display 2B according to embodiments. As illustrated in FIG. 6, the first display 2A has a first display region 200. The first display region 200 is a display plane on which the first display 2A displays a variety of information. The second display 2B has a second display region 300. The second display region 300 includes a first region 301 and a second region 302. For example, the first region 301 is a region of the second display region 300 that overlaps the first display region 200 of the first display 2A. For example, the second region 302 is a region of the second display region 300 that does not overlap the first display region 200. For example, the second region 302 is a region of the second display region 300 that overlaps the front panel 22 illustrated in FIG. 1.

In embodiments described here, the second display 2B covers substantially the whole area of the main face 21 of the housing 20. However, the embodiments are not limited thereto. For example, the second display 2B may cover only a predetermined range of the main face 21 of the housing 20. The predetermined range may be, for example, a portion of at least one of the upper side and the lower side of the first display 2A on the main face 21. The predetermined range may be, for example, a portion of the front panel 22. For example, when the smartphone 1 has an operation button and the like on the front panel 22 of the housing 20, the second display 2B may be provided on the main face 21 in such a manner as not to overlap the operation button and the like.

The second display 2D has a third display region 400 as illustrated in FIG. 3. The third display region 400 includes a region superimposed on the entire back face 26 of the housing 20. The third display region 400 may be a partial region of the back face 26 of the housing 20.

The touchscreen 2C detects contact of a finger, a pen, a stylus pen or the like with the touchscreen 2C. The touchscreen 2C can detect the position where a plurality of fingers, pens, stylus pens or the like come into contact with the touchscreen 2C. In the following description, the finger, pen, stylus pen or the like that comes into contact with the touchscreen 2C may be called “contact object” or “contact substance”.

A detection method of the touchscreen 2C may be any methods, such as capacitive, resistive, surface acoustic wave (or ultrasonic wave), infrared, electromagnetic inductive, and load detection methods. In the following description, it is assumed that the user touches the touchscreen 2C using a finger to operate the smartphone 1, for simplicity of explanation.

The smartphone 1 identifies the kind of gestures, based on at least one of the contact detected by the touchscreen 2C, the position where the contact is detected, a change of the position where the contact is detected, the interval at which the contact is detected, and the number of times the contact is detected. The gesture is an operation performed on the touchscreen 2C. Examples of the gesture identified by the smartphone 1 include, but are not limited to, touch, long-touch, release, swipe, tap, double-tap, long-tap, drag, flick, pinch-in, pinch-out, etc.

The smartphone 1 operates in accordance with these gestures identified through the touchscreen 2C. User-friendly and intuitive operation is thus implemented. The operation performed by the smartphone 1 in accordance with the identified gesture may vary with the screen appearing on the first display 2A. In the following description, for simplicity of explanation, “the touchscreen 2C detects contact, and the smartphone 1 identifies the kind of gesture as X based on the detected contact” may be described as “the smartphone detects X” or “the controller detects X”.

The colored member 2E includes a plate-shaped light-transmitting colored panel colored with a coloring agent, such as a pigment, a removable light-transmitting colored cover, and a light-transmitting colored layer stacked on the second display 2D. The colored member 2E covers the whole area of the second display 2D. The colored member 2E can allow the user to visually recognize the second display 2D, the back face 26 of the housing 20, and the like behind. Examples of the color of the colored member 2E include, but are not limited to, yellow, red, green, blue, etc. When the second display 2D is in the reflective state ST2, the colored member 2E can allow the user to visually recognize the second display 2D in the color of the colored member 2E. In embodiments described here, the colored member 2E is a colored panel.

In embodiments described here, the smartphone 1 does not have a touchscreen 2C on the back face 26 of the housing 20. However, the embodiments are not limited thereto. For example, the smartphone 1 may have a touchscreen 2C covering the second display 2D on the back face 26 of the housing 20.

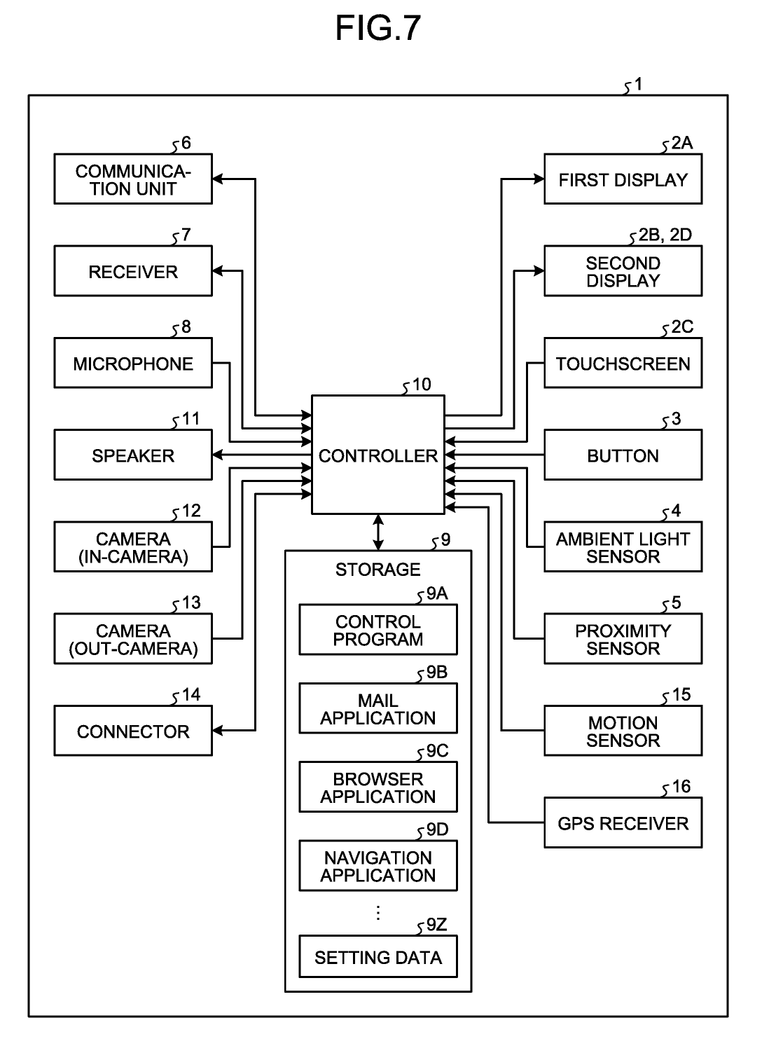

FIG. 7 is a block diagram of the smartphone 1 according to embodiments. The smartphone 1 has a first display 2A, second displays 2B and 2D, a touchscreen 2C, a button 3, an ambient light sensor 4, a proximity sensor 5, a communication unit 6, a receiver 7, a microphone 8, a storage 9, a controller 10, a speaker 11, cameras 12 and 13, a connector 14, a motion sensor 15, and a global positioning system (GPS) receiver 16.

The first display 2A displays characters, images, symbols, graphics and the like. The second displays 2B and 2D display characters, images, symbols, graphics and the like. The second display 2B displays an image that masks the first display 2A, the front panel 22 and the like. The second displays 2B and 2D display an image that decorates the smartphone 1. The touchscreen 2C detects a contact. The controller 10 detects a gesture on the smartphone 1. Specifically, the controller 10 cooperates with the touchscreen 2C to detect an operation (gesture) on the touchscreen 2C.

The button 3 is operated by the user. Examples of the button 3 include, but are not limited to, a power on/off button of the smartphone 1. The button 3 may also serve as a sleep/sleep reset button. Examples of the button 3 may include a volume control button. The controller 10 cooperates with the button 3 to detect an operation on the button 3. Examples of the operation on the button 3 include, but are not limited to, click, double-click, triple-click, push, multi-push, etc.

The ambient light sensor 4 detects the illuminance of ambient light of the smartphone 1. The illuminance is a value of luminous flux incident on a unit area of the measurement surface of the ambient light sensor 4. The ambient light sensor 4 is used, for example, for adjusting the brightness of the first display 2A. The proximity sensor 5 detects the existence of a nearby object in a contactless manner. The proximity sensor 5 detects the existence of an object, based on change of magnetic fields or change in return time of echo of ultrasound. The proximity sensor 5 detects, for example, that the first display 2A and the second display 2B are brought closer to a human face. The ambient light sensor 4 and the proximity sensor 5 may be configured as a single sensor. The ambient light sensor 4 may be used as a proximity sensor.

The communication unit 6 communicates by radio. The communication schemes supported by the communication unit 6 are wireless communication standards. Examples of the wireless communication standards include, but are not limited to, cellular phone communication standards, such as 2G, 3G, and 4G. Examples of the cellular phone communication standards include, but are not limited to, Long Term Evolution (LTE), Wideband Code Division Multiple Access (W-CDMA), Wideband Code Division Multiple Access 2000 (CDMA2000), Personal Digital Cellular (PDC), Global System for Mobile Communications (GSM) (registered trademark), Personal Handy-phone System (PHS), etc. Other examples of the wireless communication standards include Worldwide Interoperability for Microwave Access (WiMAX), IEEE 802.11, Bluetooth (registered trademark), Infrared Data Association (IrDA), and Near Field Communication (NFC). The communication unit 6 may support one or more of the communication standards described above.

The receiver 7 and the speaker 11 are an example of the output module configured to output sound. The receiver 7 and the speaker 11 can output a sound signal transmitted from the controller 10 as sound. The receiver 7 may be used, for example, for outputting voice of the other party on the line during call. The speaker 11 may be used, for example, for outputting ringer and music. One of the receiver 7 and the speaker 11 may have the other's function. The microphone 8 is an example of the input module configured to input sound. The microphone 8 can convert the user's voice or the like into a sound signal and transmit the sound signal to the controller 10.

The storage 9 can store programs and data. The storage 9 may also be used as a working area for temporarily storing the processing result of the controller 10. The storage 9 includes a recording medium. The recording medium may include any non-transitory storage medium, such as a semiconductor storage medium and a magnetic storage medium. The storage 9 may include different kinds of storage media. The storage 9 may include a combination of a portable storage medium, such as a memory card, an optical disk, or a magneto-optical disk, and a reader for the storage medium. The storage 9 may include a storage device used as a temporary storage area, such as a random access memory (RAM).

The programs stored in the storage 9 include an application executed in foreground or background and a control program supporting the operation of the application. The application allows, for example, the first display 2A to display a screen and the controller 10 to execute a process corresponding to a gesture detected through the touchscreen 2C. The control program is, for example, an operating system (OS). The application and the control program may be installed in the storage 9 through wireless communication by the communication unit 6 or a non-transitory storage medium.

The storage 9 stores, for example, a control program 9A, a mail application 9B, a browser application 9C, a navigation application 9D, and setting data 9Z. The setting data 9Z includes information related to a variety of settings related to the operation of the smartphone 1. The mail application 9B provides the email function for, for example, composing, transmitting, receiving, and displaying emails. The browser application 9C provides the Web browsing function for displaying a Web page. The navigation application 9D provides the navigation function for, for example, showing the route.

The control program 9A can provide functions related to a variety of controls for operating the smartphone 1. The control program 9A implements, for example, a call by controlling the communication unit 6, the receiver 7, the microphone 8 and the like. The functions provided by the control program 9A include the functions for performing a variety of controls, such as changing the information displayed on the first display 2A, in accordance with a gesture detected through the touchscreen 2C. The functions provided by the control program 9A include the function of controlling the display on the first display 2A and the second displays 2B and 2D. The control program 9A provides the function of limiting the acceptance of an operation on the touchscreen 2C, the button 3 and the like. The functions provided by the control program 9A include the function of detecting move, stop and the like of the user carrying the smartphone 1, based on a detection result of the motion sensor 15. The functions provided by the control program 9A may be used in combination with the functions provided by other programs, such as the mail application 9B.

The setting data 9Z includes condition data for determining a predetermined condition for switching between a display state and a hidden state of the first display 2A. The display state includes a state in which display on the first display 2A is enabled. The hidden state includes a state in which display on the first display 2A is disabled and a state in which the first display 2A is powered off. Examples of the predetermined condition include a condition for allowing the first display 2A to make a transition from the display state to the hidden state. Examples of the predetermined condition include a condition for determining whether a predetermined time has elapsed since termination of an operation by the user. Examples of the predetermined condition include a condition for determining whether a predetermined time has elapsed since the smartphone 1 is left still. The condition data includes a condition for allowing the first display 2A to make a transition from the display state to the hidden state. The condition data includes a condition for allowing the first display 2A to make a transition from the hidden state to the display state. The setting data 9Z includes data for setting an image appearing on the second displays 2B and 2D, a display position and the like.

The controller 10 is a processor. Examples of the processor include, but are not limited to, a central processing unit (CPU), a system-on-a-chip (SoC), a micro control unit (MCU), a field-programmable gate array (FPGA), a coprocessor, etc. The controller 10 can integrally control the operation of the smartphone 1. A variety of functions of the controller 10 are implemented based on the control of the controller 10.

Specifically, the controller 10 can execute an instruction included in a program stored in the storage 9. The controller 10 can refer to data stored in the storage 9 as necessary. The controller 10 controls a functional module based on data and instructions. The controller 10 controls the functional module to implement a variety of functions. Examples of the functional module include, but are not limited to, the first display 2A, the second display 2B, the second display 2D, the communication unit 6, the receiver 7, the speaker 11, etc. The controller 10 may change control based on a detection result of a detection module. Examples of the detection module include, but are not limited to, the touchscreen 2C, the button 3, the ambient light sensor 4, the proximity sensor 5, the microphone 8, the camera 12, the camera 13, the motion sensor 15, the GPS receiver 16, etc.

The controller 10 can execute, for example, the control program 9A to execute a variety of controls, such as changing information appearing on the first display 2A, in accordance with a gesture detected through the touchscreen 2C.

The camera 12 and the camera 13 can convert a captured image into an electrical signal. The camera 12 is an in-camera that captures an image of an object facing the front panel 22. The camera 13 is an out-camera that captures an image of an object facing the back face 26 of the housing 20.

The connector 14 is a terminal to which any other device is connected. The connector 14 may be a general terminal, such as a universal serial bus (USB), a high-definition multimedia interface (HDMI) (registered trademark), Light Peak (Thunderbolt (registered trademark)), and a headset microphone connector. The connector 14 may be a dedicated terminal, such as a dock connector. Examples of the device connected to the connector 14 include, but are not limited to, an external storage, a speaker, a communication device, etc.

The motion sensor 15 can detect a variety of information for determining the operation of the user carrying the smartphone 1. The motion sensor 15 may be configured as, for example, a sensor unit including an acceleration sensor, a direction sensor, a gyro scope, a magnetic sensor, and a pressure sensor.

The GPS receiver 16 can detect the present position of the smartphone 1. The GPS receiver 16 receives radio signals in a prescribed frequency band from GPS satellites, demodulates the received radio signals, and sends the demodulated signals to the controller 10. In embodiments described here, the smartphone 1 includes the GPS receiver 16. However, the embodiments are not limited thereto. For example, the smartphone 1 may include a receiver that receives radio signals from navigation satellites other than the GPS satellites. For example, the smartphone 1 may detect the present position based on a base station by which the communication unit 6 uses wireless communication. For example, the smartphone 1 may detect the present position using a plurality of systems in combination.

Some or all of the programs and data stored in the storage 9 in FIG. 7 may be downloaded from another device through wireless communication by the communication unit 6. Some or all of the programs and data stored in the storage 9 in FIG. 7 may be stored in a non-transitory storage medium readable by the reader included in the storage 9. Some or all of the programs and data stored in the storage 9 in FIG. 7 may be stored in a non-transitory storage medium readable by the reader connected to the connector 14. Examples of the non-transitory storage medium include, but are not limited to, an optical disk, such as CD (registered trademark), DVD (registered trademark), and Blu-ray (registered trademark), a magneto-optical disk, a magnetic storage medium, a memory card, a solid-state storage medium, etc.

The configuration of the smartphone 1 illustrated in FIG. 7 is exemplary and may be modified as appropriate without departing from the spirit of the present disclosure. Although in the example illustrated in FIG. 7, the smartphone 1 includes the button 3, the smartphone 1 may not include the button 3. Although in the example illustrated in FIG. 7, the smartphone 1 includes two cameras, the smartphone 1 may include only one camera or may not include a camera.

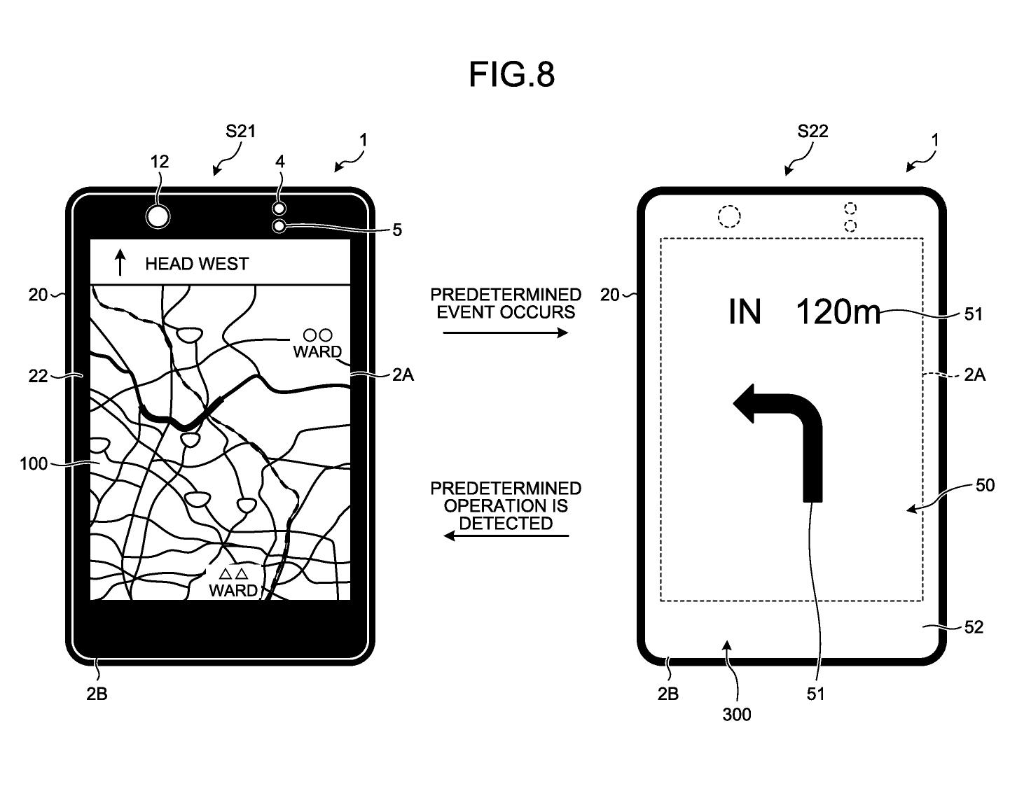

FIG. 8 is a diagram illustrating an example of display control performed by the smartphone 1 according to embodiments. The smartphone 1 executes the navigation application 9D and displays a screen 100 on the first display 2A, as illustrated in state S21 in FIG. 8. In state S21, the smartphone 1 sets the whole area of the second display 2B to the transmissive state ST1. The smartphone 1 can allow light from the first display 2A to be transmitted through the transparent second display 2B and emitted to the outside of the smartphone 1. As a result, the user can visually recognize the emitted light and thereby visually recognize the screen 100 appearing on the first display 2A through the transparent second display 2B.

For example, in state S21, the smartphone 1 displays a map screen as the screen 100 on the first display 2A and navigates based on the route to the goal set by the user and the present position of the device. In the smartphone 1, when the present position of the device satisfies a guide condition, an event occurs for notifying the user of information for guiding the user. Examples of the guide condition include, but are not limited to, conditions such as detecting an approach to a position to turn left or right, detecting an approach to a landmark, detecting an approach to a goal, detecting deviation from the route, etc. In the example illustrated in state S21, when the smartphone 1 detects that the present position of the device is 120 m before the position to turn left, an event occurs for notifying the user of information for guiding the user.

When a predetermined event occurs, in state S22, the smartphone 1 allows the second display 2B to display a first image 50 corresponding to the predetermined event. Examples of the predetermined event include, but are not limited to, an event determined beforehand by an application. Examples of the predetermined event include, but are not limited to, detection of a certain operation by the user for switching the display. Examples of the certain operation include, but are not limited to, double-tap, long-touch, slide, flick, shaking the device (shake), gripping the device (grip), etc. The smartphone 1 can detect, for example, a shake operation based on the acceleration acting on the device. The smartphone 1 can detect, for example, a grip operation based on change of the pressure inside the device, the contact state of the touchscreen 2C, and the like. The first image 50 includes a transmission part 51 and a reflection part 52. The first image 50 is a combined image of the transmission part 51 and the reflection part 52. The smartphone 1 controls the second display 2B such that a portion of the second display region 300 corresponding to the transmission part 51 of the first image 50 is in the transmissive state ST1 and a portion of the second display region 300 corresponding to the reflection part 52 of the first image 50 is in the reflective state ST2. The smartphone 1 allows the user to visually recognize the transmission part 51 of the first image 50 through the color behind. The smartphone 1 allows the user to visually recognize the reflection part 52 of the first image 50 through the color of the opaque second display 2B.

In the example illustrated in FIG. 8, the first image 50 is an image that hides the first display 2A and the front panel 22. However, the first image 50 is not limited thereto. For example, the first image 50 may be an image that hides the first display 2A alone. The transmission part 51 of the first image 50 includes an image of a character, an arrow and the like as a notice. The reflection part 52 of the first image 50 includes a background image. The smartphone 1 may display a part of the first display 2A overlapping with the transmission part 51 of the first image 50 in the display color of the transmission part 51. For example, the smartphone 1 may render the color behind the transmission part 51 of the first image 50 in black to allow the user to visually recognize the transmission part 51 in black. The smartphone 1 may be configured such that the reflection part 52 of the first image 50 includes an image of a character, an arrow and the like as a notice and the transmission part 51 of the first image 50 includes a background image.

The smartphone 1 can hide a portion of the first display 2A overlapping with the first image 50 under the reflection part 52 of the first image 50. The smartphone 1 can display the first image 50 on the front panel 22 that is unable to be displayed by the first display 2A. The user easily becomes aware of the change of the display contents by visually recognizing the switching from the screen 100 on the first display 2A to the first image 50 on the second display 2B. The smartphone 1 can hide the screen 100 on the first display 2A and increase the possibility of making the user understand information related to a predetermined event through the first image 50. The smartphone 1 uses a polymer network liquid crystal as the second display 2B, and therefore, when the first image 50 is appearing on the second display 2B, the external light visibility can be improved, and power consumption can be suppressed compared with display by the first display 2A.

In state S22, when detecting a predetermined operation corresponding to a predetermined event, the smartphone 1 hides the first image 50 appearing on the second display 2B and makes a transition to state S21. That is, the smartphone 1 allows the whole area of the second display 2B to make a transition to the transmissive state ST1. The smartphone 1 switches from a state in which the first image 50 appears on the second display 2B to a state in which the screen 100 appears on the first display 2A, in response to a predetermined operation. Examples of the predetermined operation include, but are not limited to, an operation determined beforehand by the user, an operation such as moving the device by the user (including the movement of the user), etc. Examples of the operation determined beforehand by the user include, but are not limited to, operations, such as double-tap, long-touch, slide, flick, shaking the device (shake), and gripping the device (grip). The smartphone 1 can detect the operation such as moving the device, for example, based on the acceleration acting on the device.

The smartphone 1 can display the first image 50 related to a predetermined event on the second display 2B until a predetermined operation is detected after the predetermined event occurs. As a result, the smartphone 1 can continuously display the first image 50 related to the predetermined event, thereby preventing the user from missing information. In the example illustrated in FIG. 8, the smartphone 1 can allow the user to recognize that the user is approaching the position to turn left.

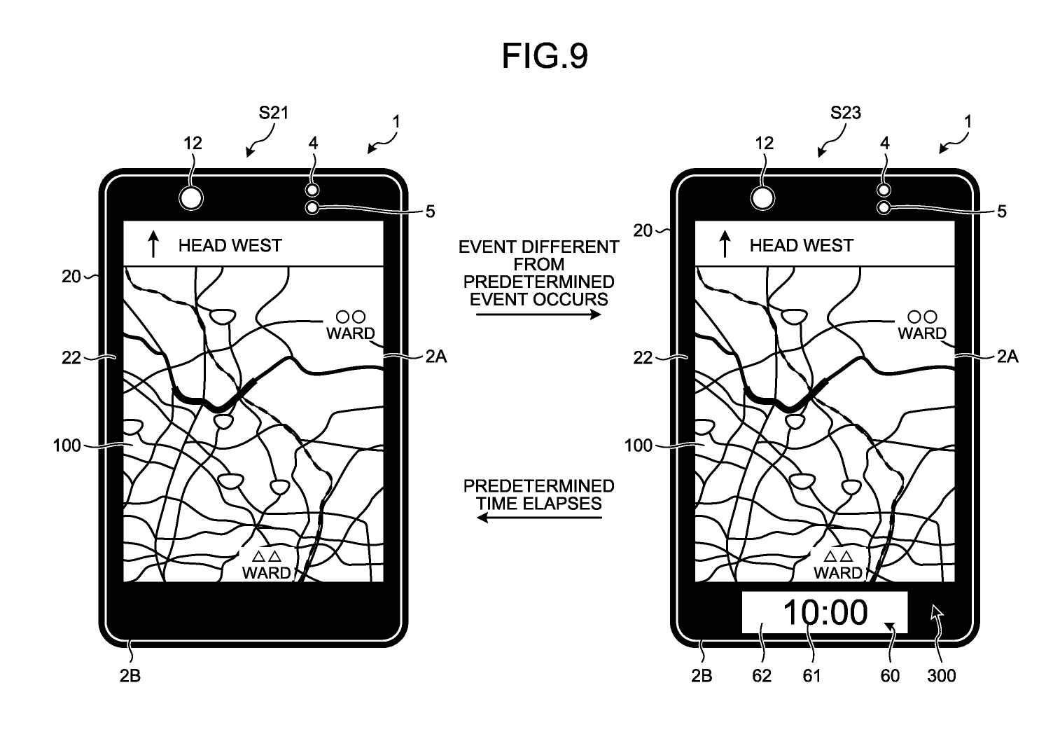

FIG. 9 is a diagram illustrating another example of display control performed by the smartphone 1 according to embodiments. The smartphone 1 executes the navigation application 9D and displays the screen 100 on the first display 2A as illustrated in state S21 in FIG. 9. State S21 illustrated in FIG. 9 is the same as state S21 illustrated in FIG. 8.

In state S21, when an event different from a predetermined event occurs, the smartphone 1 makes a transition to state S23. Examples of the event different from a predetermined event include, but are not limited to, an event irrelevant to the running application. For example, when an event of time signal occurs, in state S23, the smartphone 1 displays a second image 60 related to the time signal on the second display 2B. The second image 60 includes a transmission part 61 and a reflection part 62. The second image 60 is a combined image of the transmission part 61 and the reflection part 62. The smartphone 1 controls the second display 2B such that a portion of the second display region 300 corresponding to the transmission part 61 of the second image 60 is in the transmissive state ST1 and a portion of the second display region 300 corresponding to the reflection part 62 of the second image 60 is in the reflective state ST2. The smartphone 1 allows the user to visually recognize the transmission part 61 of the second image 60 through the color behind. The smartphone 1 allows the user to visually recognize the reflection part 62 of the second image 60 through the color of the opaque second display 2B.

In the example illustrated in FIG. 9, in the smartphone 1, the second image 60 is an image that is overlapped with the front panel 22 of the housing 20 and is not overlapped with the first display 2A. However, the embodiments are not limited thereto. For example, in the smartphone 1, the second image 60 may be an image covering the entire front panel 22, in the same manner as in state S22 illustrated in FIG. 8. The transmission part 61 of the second image 60 may include an image of a numeral as a notice. The reflection part 62 of the second image 60 includes a background image. The smartphone 1 may have the second image 60 overlapped on the first display 2A.

In state S23, when a predetermined time has elapsed since an event different from a predetermined event occurs, the smartphone 1 hides the second image 60 and makes a transition to state S21. The smartphone 1 does not permanently display the second image 60 not related to the predetermined event. As a result, the smartphone 1 can display information related to a predetermined event and information not related to a predetermined event in different display manners and thereby can improve the user's convenience.

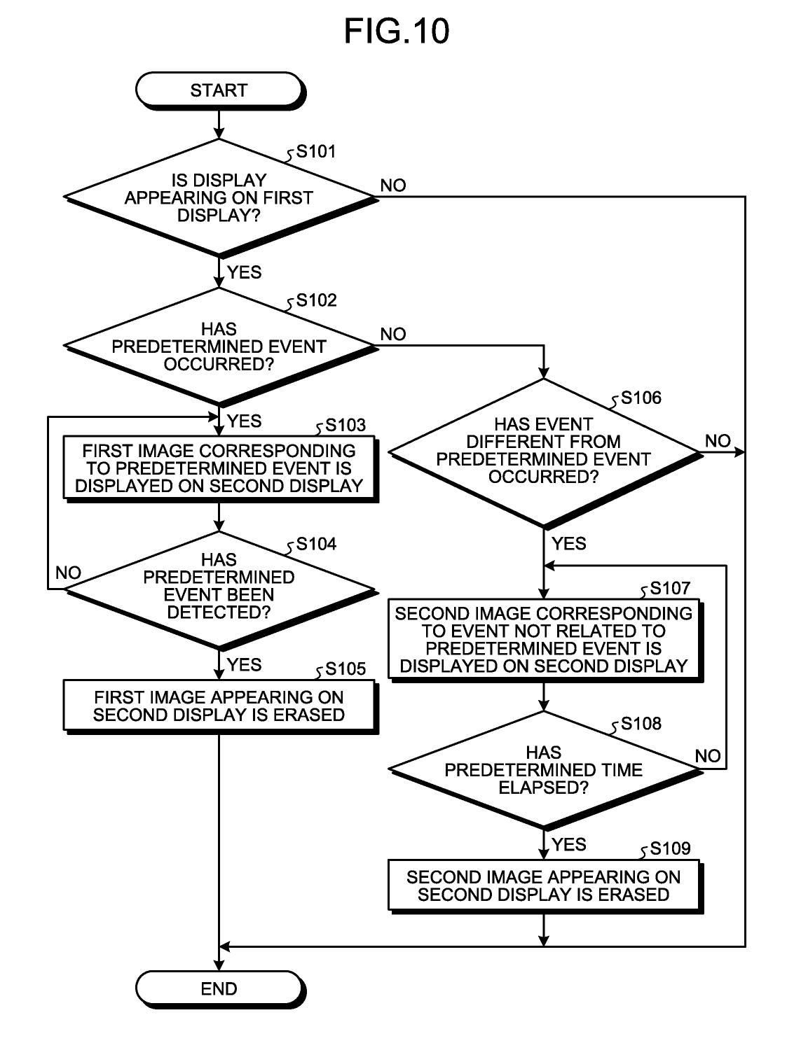

FIG. 10 is a flowchart illustrating the procedure of an example of display control performed by the smartphone 1 according to embodiments. The procedure illustrated in FIG. 10 is implemented by the controller 10 executing the control program 9A. The procedure illustrated in FIG. 10 is repeatedly executed by the controller 10.

As illustrated in FIG. 10, the controller 10 of the smartphone 1 determines whether display is appearing on the first display 2A (Step S101). For example, if some information is appearing on the first display 2A, the controller 10 determines that display is appearing on the first display 2A. If it is determined that display is not appearing on the first display 2A (No at Step S101), the controller 10 terminates the procedure illustrated in FIG. 10. If it is determined that display is appearing on the first display 2A (Yes at Step S101), the controller 10 moves the process to Step S102.

The controller 10 determines whether a predetermined event has occurred (Step S102). For example, if the occurrence of a predetermined event is detected while display is appearing on the first display 2A, the controller 10 determines that a predetermined event has occurred. For example, if the occurrence of a predetermined event is detected while a predetermined application is running, the controller 10 determines that a predetermined event has occurred. If it is determined that a predetermined event has occurred (Yes at Step S102), the controller 10 moves the process to Step S103.

The controller 10 allows the second display 2B to display the first image 50 corresponding to a predetermined event (Step S103). For example, the controller 10 specifies the first image 50 corresponding to a predetermined event and allows the second display 2B to display the specified first image 50. For example, after allowing the second display 2B to display the first image 50, the controller 10 may hide the first display 2A. The controller 10 allows the second display 2B to display the first image 50 and then moves the process to Step S104.

The controller 10 determines whether a predetermined operation has been detected (Step S104). For example, if an operation or movement corresponding to the first image 50 has been detected, the controller 10 determines that a predetermined operation has been detected. If it is determined that a predetermined operation has not been detected (No at Step S104), the controller 10 returns the process to Step S103 previously described. If it is determined that a predetermined operation has been detected (Yes at Step S104), the controller 10 moves the process to Step S105.

The controller 10 erases the first image 50 appearing on the second display 2B (Step S105). For example, if the first display 2A is hidden while the first image 50 is being displayed, the controller 10 returns the first display 2A to the state before hiding display. The controller 10 erases the first image 50 and then terminates the procedure illustrated in FIG. 10.

If it is determined that a predetermined event has not occurred (No at Step S102), the controller 10 moves the process to Step S106. The controller 10 determines whether an event different from a predetermined event has occurred (Step S106). For example, if detecting the occurrence of an event that is different from a predetermined event and is permitted to temporarily appear while display is appearing on the first display 2A, the controller 10 determines that an event different from a predetermined event has occurred. If it is determined that an event different from a predetermined event has not occurred (No at Step S106), the controller 10 terminates the procedure illustrated in FIG. 10.

If it is determined that an event different from a predetermined event has occurred (Yes at Step S106), the controller 10 moves the process to Step S107. The controller 10 allows the second display 2B to display the second image 60 corresponding to an event not related to a predetermined event (Step S107). For example, the controller 10 specifies the second image 60 corresponding to an event not related to a predetermined event and allows the second display 2B to display the specified second image 60. For example, the controller 10 allows the second display 2B to display the second image 60 while keeping the display state of the first display 2A. For example, the controller 10 display the second image 60 at a position in the second display 2B that does not overlap the first display 2A. The controller 10 may display the second image 60 at a position in the second display 2B that overlaps the first display 2A in. For example, the controller 10 may allow the second display 2D to display the second image 60, the second display 2D being provided on the back face 26 of the housing 20.

The controller 10 determines whether a predetermined time has elapsed since allowing the second display 2B to display the second image 60 (Step S108). For example, the controller 10 determines that a predetermined time has elapsed, for example, if the difference between the time at which the display on the second image 60 is started and the present time exceeds a predetermined time, or if a timer activated when a predetermined event occurs times out. If it is determined that a predetermined time has not elapsed (No at Step S108), the controller 10 returns the process to Step S107 previously described. If it is determined that a predetermined time has elapsed (Yes at Step S108), the controller 10 moves the process to Step S109.

The controller 10 erases the second image 60 appearing on the second display 2B (Step S109). The controller 10 erases the second image 60 and then terminates the procedure illustrated in FIG. 10.

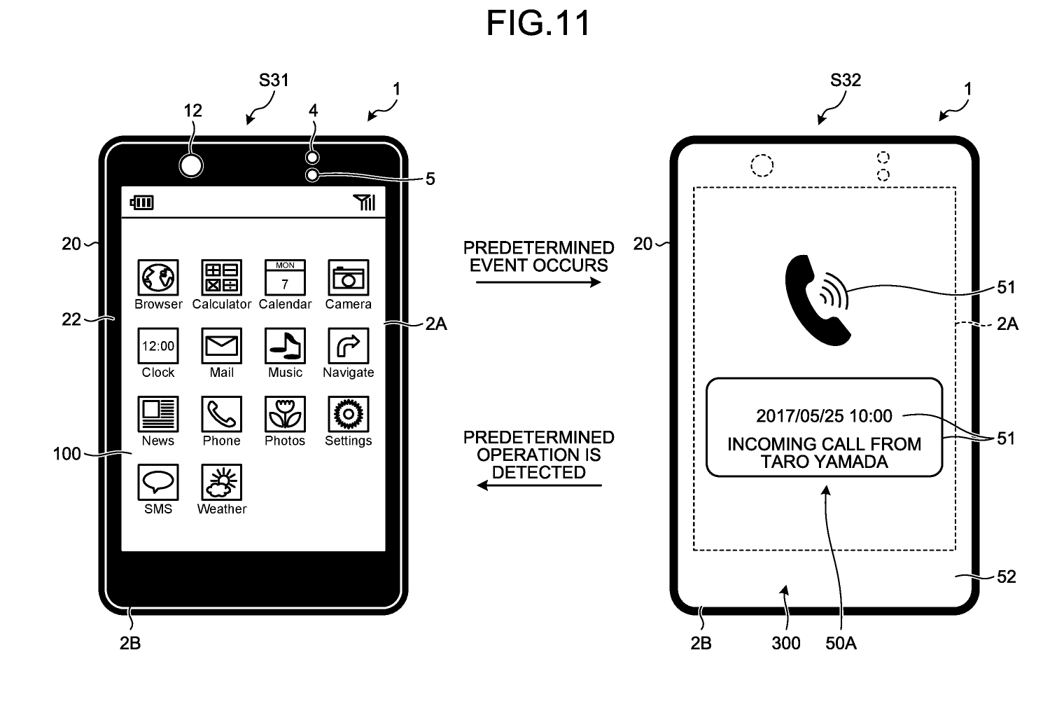

FIG. 11 is a diagram illustrating another example of display control performed by the smartphone 1 according to embodiments. The smartphone 1 executes the control program 9A and displays the screen 100 on the first display 2A, as illustrated in state S31 in FIG. 11. In state S31, the smartphone 1 sets the whole area of the second display 2B in the transmissive state ST1. The smartphone 1 can allow light from the first display 2A to be transmitted through the transparent second display 2B and emitted to the outside of the smartphone 1. As a result, the user can visually recognize the emitted light and thereby visually recognize the screen 100 appearing on the first display 2A through the transparent second display 2B.

For example, in state S31, the smartphone 1 displays the screen 100 that is a home screen on the first display 2A. The smartphone 1 detects an incoming call through the communication unit 6, and if the user does not answer, a predetermined event occurs to notify the user of the incoming call. In the example illustrated in state S31, the smartphone 1 displays the screen 100 on the first display 2A. However, the embodiments are not limited thereto. For example, the smartphone 1 may display a lock screen, a screen of another application, or the like as the screen 100.

When a predetermined event occurs, in state S32, the smartphone 1 allows the second display 2B to display a first image 50A corresponding to the predetermined event. Examples of the predetermined event include, but are not limited to, an event determined beforehand by an application. The first image 50A includes a transmission part 51 and a reflection part 52. The first image 50A is a combined image of the transmission part 51 and the reflection part 52. The smartphone 1 controls the second display 2B such that a portion of the second display region 300 corresponding to the transmission part 51 of the first image 50A is in the transmissive state ST1 and a portion of the second display region 300 corresponding to the reflection part 52 of the first image 50A is in the reflective state ST2. The smartphone 1 allows the user to visually recognize the transmission part 51 of the first image 50A through the color behind. The smartphone 1 allows the user to visually recognize the reflection part 52 of the first image 50A through the color of the opaque second display 2B.

In the example illustrated in FIG. 11, the first image 50A is an image that hides the first display 2A and the front panel 22. However, the first image 50A is not limited thereto. For example, the first image 50A may be an image that hides the first display 2A alone. The transmission part 51 of the first image 50A includes an icon representing an incoming call, an image of a label (note) representing the detail of the incoming call, and the like. The reflection part 52 of the first image 50A includes a background image. The smartphone 1 may display a portion of the first display 2A overlapping with the transmission part 51 of the first image 50A in the display color of the transmission part 51. For example, the smartphone 1 may render the color behind the transmission part 51 of the first image 50A in black, thereby allowing the user to visually recognize the transmission part 51 in black.

The smartphone 1 can hide a portion of the first display 2A overlapping with the first image 50A under the reflection part 52 of the first image 50A. The smartphone 1 can display the first image 50A on the front panel 22 that is unable to be displayed by the first display 2A. The user easily becomes aware of a change of display contents by visually recognizing the switching from the screen 100 on the first display 2A to the first image 50A on the second display 2B. The smartphone 1 can hide the screen 100 on the first display 2A and increase the possibility of making the user understand information related to a predetermined event through the first image 50A. The smartphone 1 uses a polymer network liquid crystal as the second display 2B, and therefore, when the first image 50A is appearing on the second display 2B, the external light visibility can be improved, and power consumption can be suppressed compared with display by the first display 2A.

In state S32, when a predetermined operation corresponding to a predetermined event is detected, the smartphone 1 hides the first image 50A appearing on the second display 2B and makes a transition to state S31. That is, the smartphone 1 allows the whole area of the second display 2B to make a transition to the transmissive state ST1. The smartphone 1 switches from a state in which the first image 50A appears on the second display 2B to a state in which the screen 100 appears on the first display 2A, in response to a predetermined operation.

The smartphone 1 can display the first image 50A related to a predetermined event on the second display 2B until a predetermined operation is detected after the predetermined event occurs. As a result, the smartphone 1 can continuously display the first image 50A related to the predetermined event, thereby preventing the user from missing information related to a predetermined event. In the example illustrated in FIG. 11, the smartphone 1 can prevent the user from missing information related to an incoming call.

In state S31, when an event different from a predetermined event occurs, the smartphone 1 displays the second image 60 corresponding to the event on the second display 2B, in the same manner as in the example illustrated in FIG. 9. The smartphone 1 hides the second image 60 when a predetermined time elapses after the second image 60 is displayed on the second display 2B. In this case, the smartphone 1 continues display of the screen 100 illustrated in state S31 on the first display 2A.

The smartphone 1 can use the procedure illustrated in FIG. 10 for the procedure of display control of state S31 and state S32 illustrated in FIG. 11, and a description thereof will be omitted. That is, the controller 10 of the smartphone 1 can implement the display control illustrated in FIG. 11 by repeatedly executing the procedure illustrated in FIG. 10.

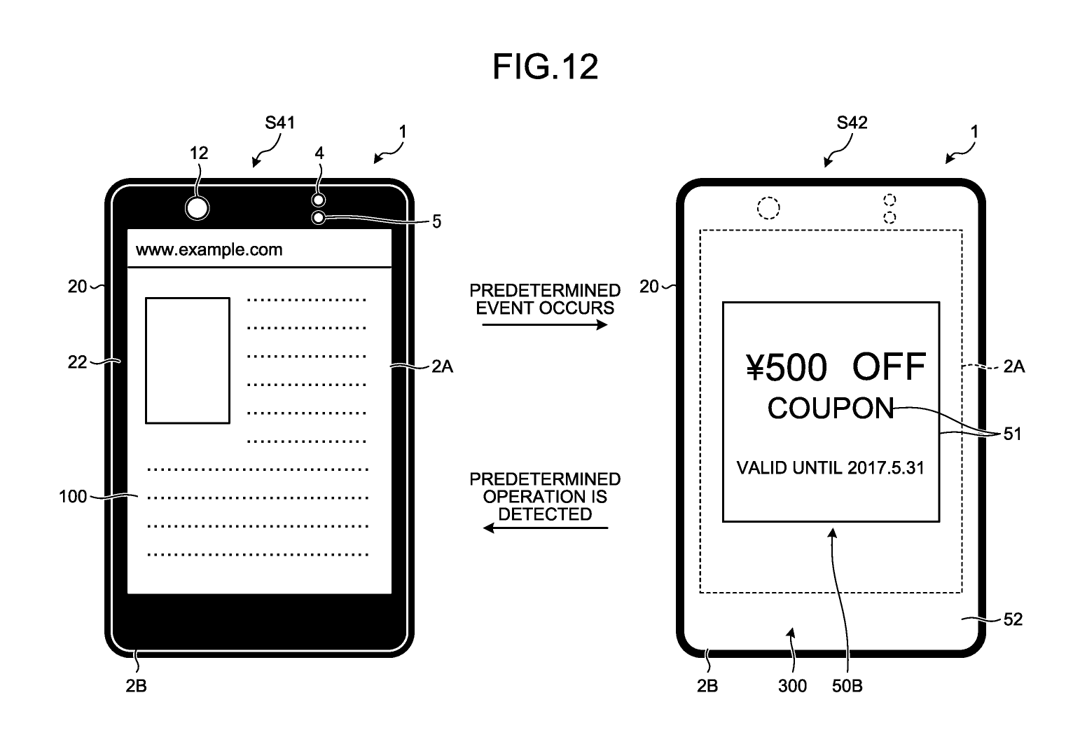

FIG. 12 is a diagram illustrating another example of display control performed by the smartphone 1 according to embodiments. The smartphone 1 executes the browser application 9C and displays the screen 100 on the first display 2A as illustrated in state S41 in FIG. 12. In the example illustrated in FIG. 12, the screen 100 includes a browser screen displayed by the browser application 9C. In state S41, the smartphone 1 sets the whole area of the second display 2B in the transmissive state ST1. The smartphone 1 can allow light from the first display 2A to be transmitted through the transparent second display 2B and emitted to the outside of the smartphone 1. As a result, the user can visually recognize the emitted light and thereby visually recognize the screen 100 appearing on the first display 2A through the transparent second display 2B.

For example, in state S41, the smartphone 1 displays the screen 100 that is a browser screen on the first display 2A. In this case, a predetermined event may occur, in which the smartphone 1 receives a request to display a coupon from a server or the like, in response to the user's operation on the screen 100.

When a predetermined event occurs, in state S42, the smartphone 1 allows the second display 2B to display a first image 50B corresponding to the predetermined event. The first image 50B has a transmission part 51 and a reflection part 52. The first image 50B is a combined image of the transmission part 51 and the reflection part 52. The smartphone 1 controls the second display 2B such that a portion of the second display region 300 corresponding to the transmission part 51 of the first image 50B is in the transmissive state ST1 and a portion of the second display region 300 corresponding to the reflection part 52 of the first image 50B is in the reflective state ST2. The smartphone 1 allows the user to visually recognize the transmission part 51 of the first image 50B through the color behind. The smartphone 1 allows the user to visually recognize the reflection part 52 of the first image 50B through the color of the opaque second display 2B.

In the example illustrated in FIG. 12, the first image 50B is an image that hides the first display 2A and the front panel 22. However, the first image 50B is not limited thereto. For example, the first image 50B may be an image that hides the first display 2A alone. The transmission part 51 of the first image 50B includes an image representing a character, a numeral, a frame and the like of the coupon. The reflection part 52 of the first image 50B includes a background image. The smartphone 1 may display a portion of the first display 2A overlapping with the transmission part 51 of the first image 50B in the display color of the transmission part 51. For example, the smartphone 1 may render the color behind the transmission part 51 of the first image 50B in red, yellow or the like to allow the user to visually recognize the transmission part 51 in red, yellow or the like.

The smartphone 1 can hide a portion of the first display 2A overlapping with the first image 50B under the reflection part 52 of the first image 50B. The smartphone 1 can display the first image 50B on the front panel 22 that is unable to be displayed by the first display 2A. The user easily becomes aware of a change of display contents by visually recognizing the switching from the screen 100 on the first display 2A to the first image 50B on the second display 2B. The smartphone 1 can hide the screen 100 on the first display 2A and improve the possibility of making the user understand information related to a predetermined event through the first image 50B. The smartphone 1 uses a polymer network liquid crystal as the second display 2B, and therefore, when the first image 50B is appearing on the second display 2B, the external light visibility can be improved, and power consumption can be suppressed compared with display by the first display 2A.

In state S42, when a predetermined operation corresponding to a predetermined event is detected, the smartphone 1 hides the first image 50B appearing on the second display 2B and makes a transition to state S41. That is, the smartphone 1 allows the whole area of the second display 2B to make a transition to the transmissive state ST1. The smartphone 1 switches from a state in which the first image 50B appears on the second display 2B to a state in which the screen 100 appears on the first display 2A, in response to a predetermined operation.

In state S41, when an event different from a predetermined event occurs, the smartphone 1 displays the second image 60 corresponding to the event on the second display 2B, in the same manner as in the example illustrated in FIG. 9. The smartphone 1 hides the second image 60 when a predetermined time elapses after the second image 60 is displayed on the second display 2B. In this case, the smartphone 1 continues display of the screen 100 illustrated in state S41 on the first display 2A.

The smartphone 1 can use the procedure illustrated in FIG. 10 for the procedure of display control of state S41 and state S42 illustrated in FIG. 12, and a description thereof will be omitted. That is, the controller 10 of the smartphone 1 can implement the display control illustrated in FIG. 12 by repeatedly executing the procedure illustrated in FIG. 10.

The embodiments disclosed in the subject application can be modified without departing from the spirit and the scope of the invention. The embodiments disclosed in the subject application can be combined as appropriate. For example, the foregoing embodiments may be modified as follows.

In the examples of display control described with reference to FIG. 8 to FIG. 12, when it is determined that an event different from a predetermined event has occurred, the smartphone 1 allows the second display 2B to display the second image 60 corresponding to the event not related to the predetermined event. However, the embodiments are not limited thereto. When it is determined that an event different from a predetermined event has occurred, the smartphone 1 may display the second image 60 corresponding to the event not related to a predetermined event on the first display 2A.

For example, each program illustrated in FIG. 7 may be divided into a plurality of modules or may be combined with another program.

In the foregoing embodiments, the smartphone 1 has the second display 2D on the back face 26 of the housing 20. The smartphone 1 may allow the second display 2D to display information such as the first image 50 and the second image 60 described above.

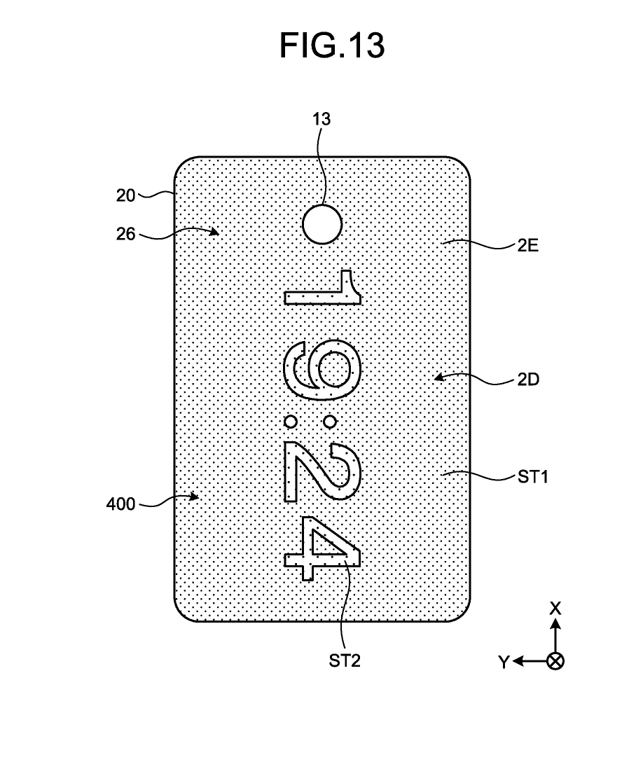

FIG. 13 is a diagram illustrating another example of display control performed by the smartphone 1 according to embodiments. As illustrated in FIG. 13, the smartphone 1 has a light-transmitting colored member 2E superimposed on the second display 2D on the back face 26. The smartphone 1 allows the second display 2D on the back face 26 to display information to allow the user to visually recognize the portion in the reflective state ST2 of the second display 2D in such a manner as to shine in the color of the colored member 2E.

In the example illustrated in FIG. 13, the smartphone 1 sets a numeral portion in the reflective state ST2 and a background portion in the transmissive state ST1. As a result, the smartphone 1 can allow the user to visually recognize the numeral portion appearing on the second display 2D in such a manner as to shine in the color of the colored member 2E. In the smartphone 1, the portion in the transmissive state ST1 of the second display 2D is darker than the portion in the reflective state ST2. The smartphone 1 can allow the second display 2D on the back face 26 to display information such as the first image 50 and the second image 60, thereby increasing the variety of manners of display. Since the smartphone 1 uses a polymer network liquid crystal as the second display 2D, the external light visibility can be improved, and power consumption can be suppressed.

In the foregoing embodiments, the smartphone 1 has the first images 50, 50A, and 50B each extending across the first region 301 and the second region 302. However, the embodiments are not limited thereto. For example, the smartphone 1 may display the image of the second display 2B in one of the first region 301 or the second region 302.

In the foregoing embodiments, the smartphone 1 has the second displays 2B and 2D having a substantially rectangular shape. However, the second displays 2B and 2D are not limited thereto. For example, the smartphone 1 may have the second displays 2B and 2D each having a shape, such as a polygon, an oval, or a star.

In the foregoing embodiments, the smartphone 1 has the touchscreen 2C having a size substantially equal to the size of the first display 2A. However, the size of the touchscreen 2C is not limited thereto. For example, the smartphone 1 may have the touchscreen 2C having a size substantially equal to the size of the second display 2B.

In the foregoing embodiments, the smartphone 1 includes one second display 2B stacked on the display-plane side of the first display 2A. However, the embodiments are not limited thereto. For example, the smartphone 1 may have a plurality of second displays stacked on the display-plane side of the first display 2A.

In the foregoing embodiments, the smartphone 1 has the second display 2D provided on the whole area of the back face 26 of the housing 20. However, the embodiments are not limited thereto. For example, the smartphone 1 may have the second display 2D provided on a portion of the back face 26. The smartphone 1 may have the first display 2A and the second display 2D superimposed on the back face 26 of the housing 20.

In the foregoing embodiments, the smartphone 1 has the second displays 2B and 2D providing dot matrix display. However, the embodiments are not limited thereto. The second displays 2B and 2D may provide segment display or a combination of matrix display and segment display.

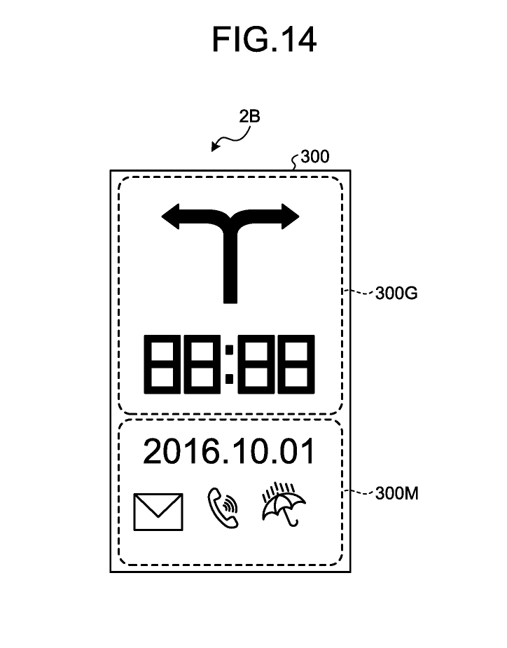

FIG. 14 is a diagram illustrating another example of the second display region 300 of the second display 2B. As illustrated in FIG. 14, the second display region 300 of the second display 2B includes a segment region 300G and a matrix region 300M. The segment region 300G can display a desired segment of a predetermined number of segments. A plurality of segments include, for example, numerals, characters, and symbols. The segment region 300G can display, for example, an arrow, a clock, and a distance/speed meter. The matrix region 300M may display a plurality of dots (pixels) in combination. The matrix region 300M can display, for example, date, text, and an alert icon. The smartphone 1 can suppress power consumption, because only a segment portion to be displayed in the segment region 300G of the second display 2B should be set to the transmissive state ST1, that is, the voltage applied state. In the second display region 300 of the second display 2B, the arrangement of the segment region 300G and the matrix region 300M is not limited to the example illustrated in FIG. 14. The third display region 400 of the second display 2D may also include a segment region and a matrix region, in the same manner as in the second display 2B.

In the foregoing embodiments, the smartphone 1 has been described as an example of the mobile electronic device. However, the mobile electronic device according to the appended claims is not limited to the smartphone 1. The mobile electronic device according to the appended claims may be an electronic device other than the smartphone 1. Examples of the electronic device include, but are not limited to, mobile phones, smart watches, portable personal computers, head-mounted displays, digital cameras, media players, electronic book readers, navigators, game consoles, etc.

The characteristic embodiments have been described in order to fully and clearly disclose the techniques according to the appended claims. The appended claims, however, should not be limited to the foregoing embodiments and should be configured in such a manner as to implement all modifications and alternative configurations that can be created by those skilled in the art within the scope of basic matters illustrated in the present specification. The means, steps, operations, functions and the like described above can be rearranged without a logical contradiction, and a plurality of means, steps, operations, functions and the like can be combined or divided in any manner.

The embodiments disclosed in the subject application can be modified without departing from the spirit and the scope of the invention. The embodiments disclosed in the subject application can be combined as appropriate. For example, the foregoing embodiments may be modified as follows.

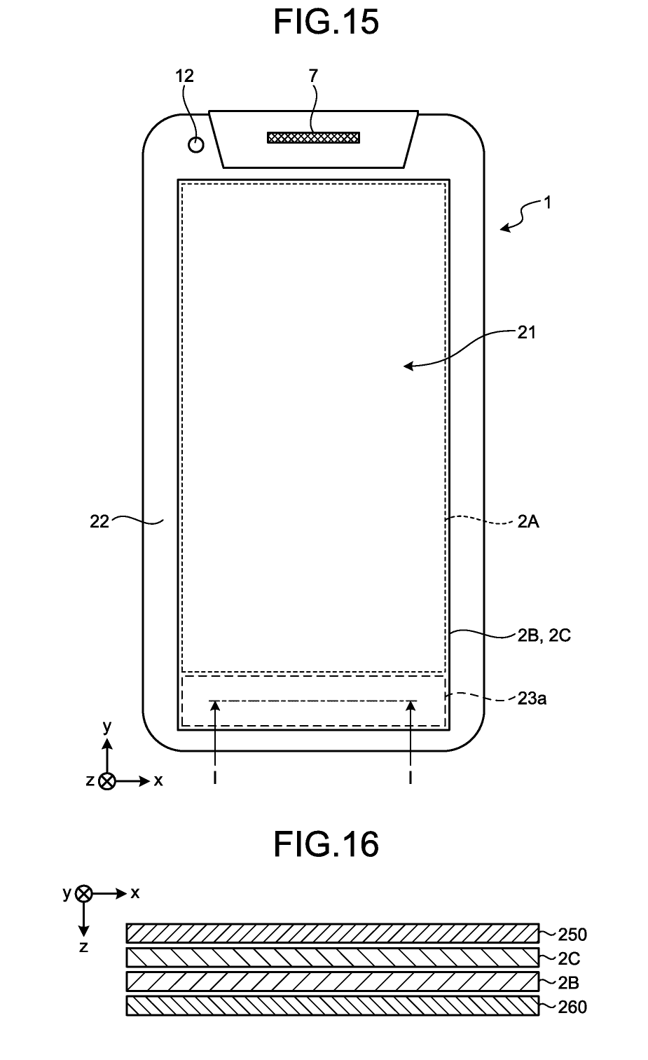

Referring to FIG. 15, an example of the external configuration of the smartphone 1 according to embodiments will be described. FIG. 15 is an example of a front view of the smartphone according to embodiments. The front face of the smartphone is a face that is opposed to the user who uses the smartphone 1 or in contact with the user and may be referred to as “front face” and “display plane” in the following description. In the following description, the face on the opposite side to the “front face” may be referred to as “back face”.

As illustrated in FIG. 15, the smartphone 1 has a box-shaped housing and has a front face 21 on the display-plane side of the housing. The front face 21 is a display plane of the smartphone 1. The smartphone 1 has a first display 2A, a second display 2B, and a touchscreen 2C on the front face 21 and has an ambient light sensor 4 (not illustrated), a proximity sensor 5 (not illustrated), a receiver 7, a camera 12, a front panel 22, a region 23a and the like.

The first display 2A has a substantially rectangular shape along the periphery of the front face 21. The first display 2A has a substantially rectangular shape but may have any shape, such as a square or a circle. In the example illustrated in FIG. 15, the first display 2A may be positioned to overlap the touchscreen 2C. When the first display 2A and the touchscreen 2C are positioned to overlap, for example, one or more sides of the first display 2A may not extend along any sides of the touchscreen 2C.

The second display 2B has a substantially rectangular shape along the periphery of the front face 21, in the same manner as the first display 2A. The second display 2B has a substantially rectangular shape but may have any shape, such as a square or a circle. In the example illustrated in FIG. 15, the second display 2B may be positioned to overlap in such a manner as to cover all of the first display 2A, the front panel 22, and the region 23a from the display-plane side of the first display 2A (the z-axis direction). In the example illustrated in FIG. 15, the second display 2B may be positioned to overlap the touchscreen 2C. When the second display 2B and the touchscreen 2C are positioned to overlap, for example, one or more sides of the second display 2B may not extend along any sides of the touchscreen 2C.

The touchscreen 2C may be physically integrated with or divided into the one positioned to overlap the first display 2A and the one positioned to overlap the second display 2B. In the example illustrated in FIG. 15, the touchscreen 2C may extend along the long sides of the first display 2A (the y-axis direction of the coordinate axes) and extend along the short sides of the first display 2A (the x-axis direction of the coordinate axes). In the example illustrated in FIG. 15, the touchscreen 2C may extend along the long sides of the second display 2B (the y-axis direction of the coordinate axes) and extend along the short sides of the second display 2B (the x-axis direction of the coordinate axes).

The region 23a is used as a display region in which an image or the like is displayed by the second display 2B and as an operation region in which the user's operation is detected by the touchscreen 2C. The region 23a used as an operation region is an example of the operation part.

FIG. 16 is a diagram schematically illustrating a cross section taken along line I-I in FIG. 15 according to embodiments. As illustrated in FIG. 16, the region 23a is configured such that a cover glass 250, the touchscreen 2C, the second display 2B, and a circuit board 260 are stacked in this order from the display plane of the smartphone 1 toward the positive direction of the Z axis. The cover glass 250 covers the whole area of the front face 21. The cover glass 250, the touchscreen 2C, the second display 2B, and the circuit board 260 may be stacked, for example, in such a manner as to be laminated with photocurable resin, adhesive, or the like.

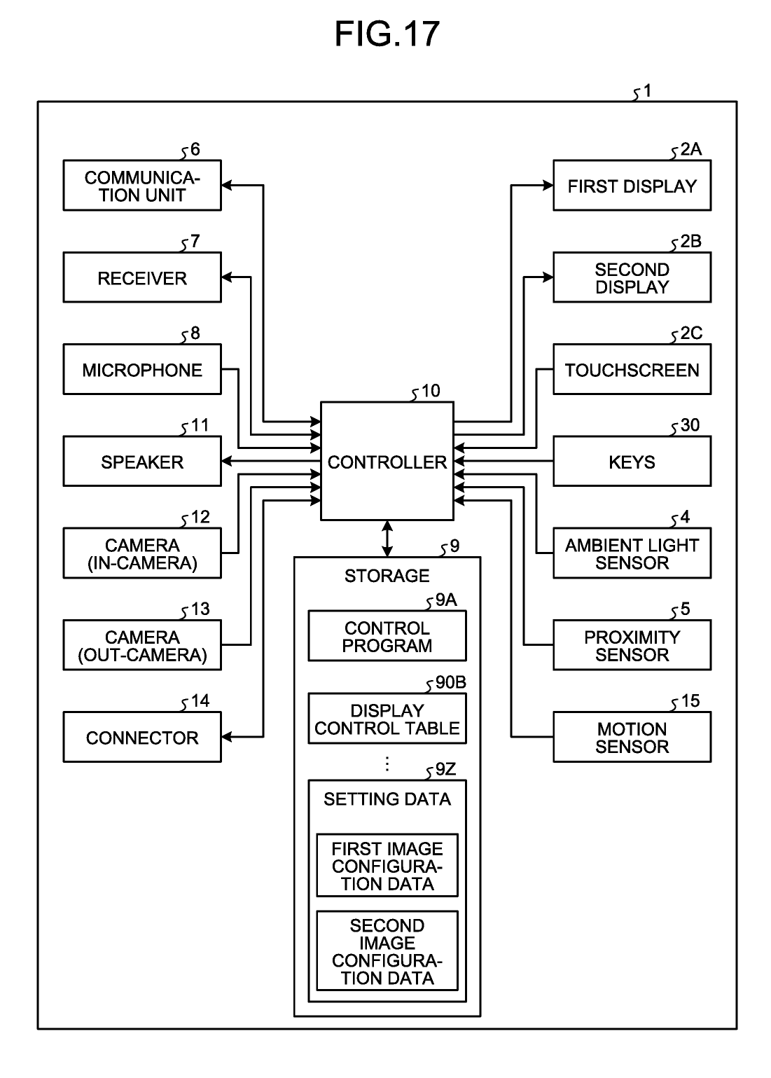

Referring to FIG. 17, an example of the functional configuration of the smartphone 1 according to an example of the embodiments will be described. FIG. 17 is a block diagram illustrating an example of the functional configuration of the smartphone according to embodiments.

As illustrated in FIG. 17, the smartphone 1 includes a first display 2A, a second display 2B, a touchscreen 2C, keys 30, an ambient light sensor 4, a proximity sensor 5, a communication unit 6, a receiver 7, a microphone 8, a storage 9, a controller 10, a speaker 11, a camera 12, a camera 13, a connector 14, and a motion sensor 15. In the following description, the smartphone 1 may be denoted as “the device”.

The first display 2A includes a display device, such as a liquid crystal display (LCD), an organic electro-luminescence display (OELD), or an inorganic electro-luminescence display (IELD). The first display 2A displays an object, such as a character, an image, a symbol, and graphics, in the screen. The screen including the object displayed by the first display 2A includes a screen called lock screen, a screen called home screen, and an application screen displayed during running of an application. The home screen may be called desk top, standby screen, idle screen, standard screen, app list screen, or launcher screen. A case where the first display 2A is a traditional liquid crystal display having a backlight will be described. The first display 2A is an example of the first display.

The second display 2B includes a display device using, for example, a network structure formed of a polymer, that is, a polymer network liquid crystal (PNLC) in which a polymer network is formed in a liquid crystal layer. In the embodiments described below, the second display 2B is a polymer network liquid crystal display. The second display 2B is an example of the second display.

A voltage is applied to change the orientation direction of liquid crystal molecules, whereby the second display 2B can switch between a transmissive state in which incident light is transmitted and a reflective state in which incident light is reflected. The second display 2B can switch between the transmissive state and the reflective state as appropriate to execute predetermined image display. The second display 2B has a configuration that allows ambient light to be reflected without using a light source such as a backlight and thus can provide image display at a brightness in accordance with the quantity of ambient light.

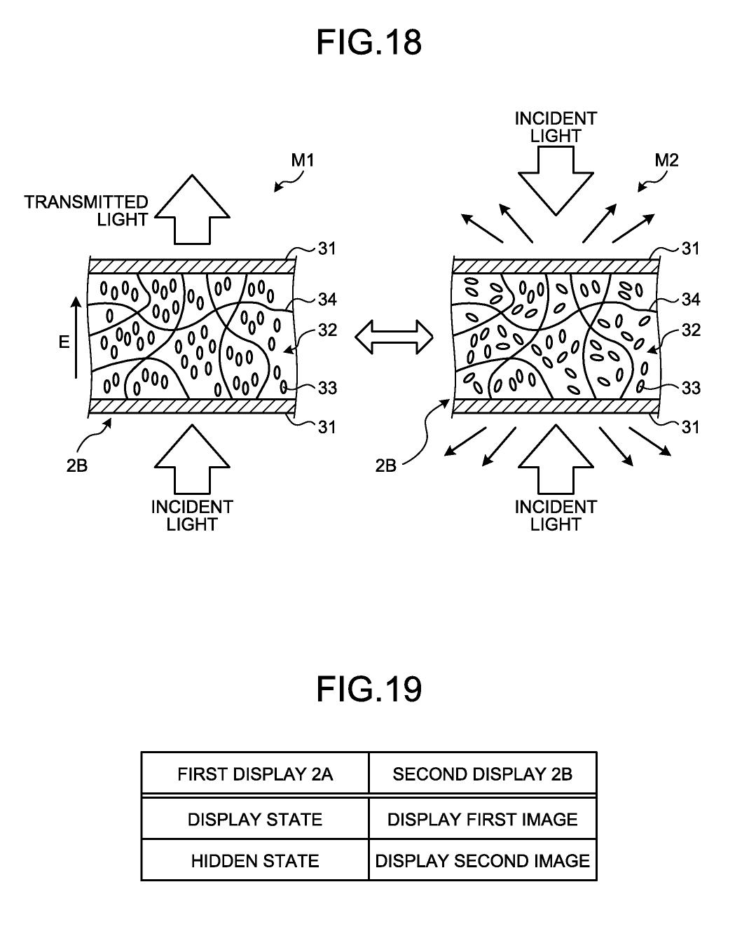

Referring to FIG. 18, the display principle of the second display according to embodiments will be described. FIG. 18 is a schematic diagram illustrating an example of the display principle of the second display according to embodiments. In the example illustrated in FIG. 18, the crystal structure of the second display 2B is mainly illustrated, and other substrate, circuit, wiring and the like are not depicted.

As illustrated in FIG. 18, the second display 2B has substrates 31 of glass or transparent films (for example, made of an organic material) and a liquid crystal layer 32. The liquid crystal layer 32 has liquid crystal molecules 33 and a polymer network 34.

The transmissive state M1 is a state in which the liquid crystal molecules 33 in the liquid crystal layer 32 are aligned in the electric field direction E by application of a voltage. In the transmissive state M1, incident light from the outside passes through the liquid crystal layer 32 without being reflected or scattered by the liquid crystal layer 32. In the transmissive state M1, the second display 2B exhibits a transparent state. When the entire display region of the second display 2B is in the transmissive state M1, the user can view the first display 2A and the like behind the second display 2B through the entire display region of the second display 2B in the transparent state. When a portion of the display region of the second display 2B is in the transmissive state M1, the user can view a portion of the first display 2A behind the second display 2B through the portion of the display region of the second display 2B in the transparent state.

The reflective state M2 is a state in which when a voltage is not applied, the liquid crystal molecules 33 are irregularly oriented by the action of the three-dimensional mesh-like polymer network 34 extending throughout the inside of the liquid crystal layer 32. In the reflective state M2, incident light from the outside is reflected or scattered by the liquid crystal layer 32. In the reflective state M2, the second display 2B exhibits a cloudy white state (opaque state). When the entire display region of the second display 2B is in the reflective state M2, the user can visually recognize the entire display region of the second display 2B in a cloudy white state. When a portion of the display region of the second display 2B is in the reflective state M2, the user can visually recognize a portion inside the display region of the second display 2B in a cloudy white state. In the example illustrated above, the second display 2B enters the transparent state by application of a voltage. However, a reverse configuration may be employed, in which the second display 2B enters the transparent state M1 in a state in which a voltage is not applied and enters the reflective state M2 in a state in which a voltage is applied. In the following description, it is assumed that the second display 2B enters the transmissive state M1 in a state in which a voltage is applied between the substrates 31 and the second display 2B enters the reflective state M2 in a state in which a voltage is not applied between the substrates 31.

The smartphone 1 executes switching between the transmissive state M1 and the reflective state M2 for the display region of the second display 2B to implement image display using the second display 2B. When executing the image display using the second display 2B, the smartphone 1 can adjust the transparency of the second display 2B such that a gradation difference that can be easily visually recognized by the user is produced between a place in the transmissive state M1 in the display region and a place in the reflective state M2 in the display region. Since the smartphone 1 has the second display 2B formed of a polymer network liquid crystal, production costs can be reduced compared with when the second display 2B is formed of electronic paper using metal plating or the like. The smartphone 1 does not require a polarizing plate for adjusting the light oscillating direction or an alignment film for controlling the alignment direction of liquid crystal molecules 33. Therefore, the smartphone 1 can be reduced in thickness compared with conventional liquid crystal displays and can be flexibly adapted to meet the design requests.

The touchscreen 2C can detect a contact or an approach of one or more fingers, one or more pens, one or more stylus pens and the like (which hereinafter may be represented by “finger”) with the touchscreen 2C. The touchscreen 2C can detect the position on the touchscreen 2C (hereinafter may be denoted as “contact position”) when one or more fingers, one or more pens, one or more stylus pens and the like come into contact with or come closer to the touchscreen 2C. The touchscreen 2C can notify the controller 10 of the contact of the finger with the touchscreen 2C together with the detected position. The operation on the touchscreen 2C can translate to the operation on the smartphone 1 having the touchscreen 2C. The touchscreen 2C can detect a contact or an approach to a region a and a region c as described later. In some embodiments, the touchscreen 2C can employ the capacitive method, the resistive method, or the load detection method as appropriate as a detection method.

The controller 10 can identify the kind of gestures based on at least one of the number of contacts detected by the touchscreen 2C, the position where the contact is detected, change of the position where the contact is detected, the time duration in which the contact is detected, the time interval at which the contact is detected, and the number of times the contact is detected. The smartphone 1 having the controller 10 can execute the operation performed by the controller 10. In other words, the operation performed by the controller 10 may be performed by the smartphone 1. The gesture is an operation performed on the touchscreen 2C using finger. The operation performed on the touchscreen 2C may be performed on the second display 2B positioned to overlap the first display 2A superimposed on the touchscreen 2C. Examples of the gesture identified by the controller 10 through the touchscreen 2C include, but are not limited to, touch, long-touch, release, swipe, tap, double-tap, long-tap, drag, flick, pinch-in, pinch-out, etc.

The keys 30 accept an operation input from the user. When accepting an operation input from the user, the keys 30 notify the controller 10 that an operation input has been accepted. “The keys 30” is the generic term of virtual keys as described below or physical keys, such as an operation key, a power key, a screen lock key, and a volume control key.

The ambient light sensor 4 can detect illuminance. The illuminance is the value of luminous flux incident on a unit area of the measurement surface of the ambient light sensor 4. The ambient light sensor 4 may be used, for example, for adjusting the luminance of the first display 2A.

The proximity sensor 5 can detect the existence of a nearby object in a contactless manner. The proximity sensor 5 detects the existence of an object based on change in magnetic field or change in return time of echo of ultrasound. The proximity sensor 5 may be used, for example, for detecting that the user's face comes closer to the first display 2A (or the front face 21). The ambient light sensor 4 and the proximity sensor 5 may be configured as a single sensor. The ambient light sensor 4 may be used as a proximity sensor.

The communication unit 6 can communicate by radio. The communication unit 6 supports wireless communication standards. Examples of the wireless communication standards supported by the communication unit 6 include, but are not limited to, cellular phone communication standards, such as 2G, 3G, and 4G, and short-range wireless communication standards. Examples of the cellular phone communication standards include, but are not limited to, Long Term Evolution (LTE), Wideband Code Division Multiple Access (W-CDMA), Worldwide Interoperability for Microwave Access (WiMAX) (registered trademark), CDMA2000, Personal Digital Cellular (PDC), Global System for Mobile Communications (GSM) (registered trademark), Personal Handy-phone System (PHS), etc. Examples of the short-range wireless communication standards include, but are not limited to, IEEE 802.11 (IEEE is the abbreviation of The Institute of Electrical and Electronics Engineers, Inc.), Bluetooth (registered trademark), Infrared Data Association (IrDA), Near Field Communication (NFC), Wireless Personal Area Network (WPAN), etc. Examples of the WPAN communication standards include, but are not limited to, ZigBee (registered trademark), Digital Enhanced Cordless Telecommunications (DECT), Z-Wave, Wireless Smart Utility Network (WiSun), etc. The communication unit 6 may support one or more of the communication standards described above.

The receiver 7 can output a sound signal transmitted from the controller 10 as sound. The receiver 7 can output, for example, sound of moving images played on the smartphone 1, and sound of music, and voice of the other party on the line during call. The microphone 8 converts the user's voice and the like into a sound signal and transmits the converted signal to the controller 10.

The storage 9 can store programs and data. The storage 9 may be used as a working area for temporarily storing the processing result of the controller 10. The storage 9 may include any non-transitory storage medium, such as a semiconductor storage medium and a magnetic storage medium. The storage 9 may include different kinds of storage media. The storage 9 may include a combination of a storage medium, such as a memory card, an optical disk, or a magneto-optical disk, and a reader for the storage medium. The storage 9 may include a storage device used as a temporary storage area, such as a random access memory (RAM).

The program stored in the storage 9 includes an application executed in foreground or background and a basic program supporting the operation of the application. A screen of the application appears on the display 2A, for example, when the application is executed in foreground. Examples of the basic program include an operating system (OS). The application and the basic program may be installed in the storage 9 through wireless communication by the communication unit 6 or a non-transitory storage medium.

The storage 9 can store a control program 9A, a display control table 90B, setting data 9Z and the like.

The control program 9A can provide each of the functions for implementing processing related to a variety of operations of the smartphone 1. The functions provided by the control program 9A include the function of adjusting the luminance of the first display 2A based on a detection result of the ambient light sensor 4. The functions provided by the control program 9A include the function of disabling an operation on the touchscreen 2C, based on a detection result of the proximity sensor 5. The functions provided by the control program 9A include the function of implementing a call by controlling the communication unit 6, the receiver 7, the microphone 8 and the like. The functions provided by the control program 9A include the function of controlling imaging processing of the camera 12 and the camera 13. The functions provided by the control program 9A include the function of controlling communication with an external device through the connector 14. The functions provided by the control program 9A include the function of performing a variety of controls, such as changing information appearing on the first display 2A, in accordance with the gesture identified based on a detection result of the touchscreen 2C. The functions provided by the control program 9A include the function of detecting move, stop and the like of the user carrying the smartphone 1, based on a detection result of the motion sensor 15.

The functions provided by the control program 9A can provide the function of the smartphone 1 for allowing the second display 2B to display a first image when the first display 2A is in a display state and for allowing the second display 2B to display a second image when the first display 2A is in a hidden state. The first image is decided by first image configuration data described later. The second image is decided by second image configuration data described later.

The display control table 90B is referred to when the smartphone 1 executes the processing by the functions provided by the control program 9A. FIG. 19 is a diagram illustrating an example of the display control table according to embodiments. In the display control table 90B, information of images to be displayed on the second display 2B is set in association with the states of the first display 2A. In the example illustrated in FIG. 19, it is set that the first image is displayed on the second display 2B when the first display 2A is in the display state, and it is set that the second image is displayed on the second display 2B when the first display 2A is in the hidden state.

The setting data 9Z includes a variety of data for use in processing in the smartphone 1. The setting data 9Z includes first image configuration data and second image configuration data.

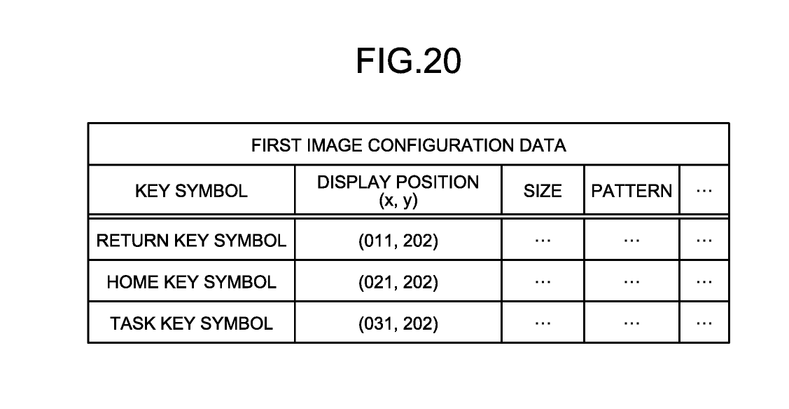

FIG. 20 is a diagram illustrating an example of the first image configuration data according to embodiments. As illustrated in FIG. 20, the first image configuration data is configured such that a plurality of key symbols are each associated with the display position of the key symbol, the display size of the key symbol, and the display pattern that is the design of the key symbol. The key symbol is a mark used when a virtual key allocated the function used for operating, for example, an image appearing on the first display 2A is displayed in the region 23a. The display position stores two-dimensional coordinate values (x, y) for specifying a position in the region 23a. In the example illustrated in FIG. 20, the first image configuration data stores three key symbols, namely, a return key symbol, a home key symbol, and a task key symbol. In the following description, the return key, the home key, and the task key are collectively referred to as navigation key.

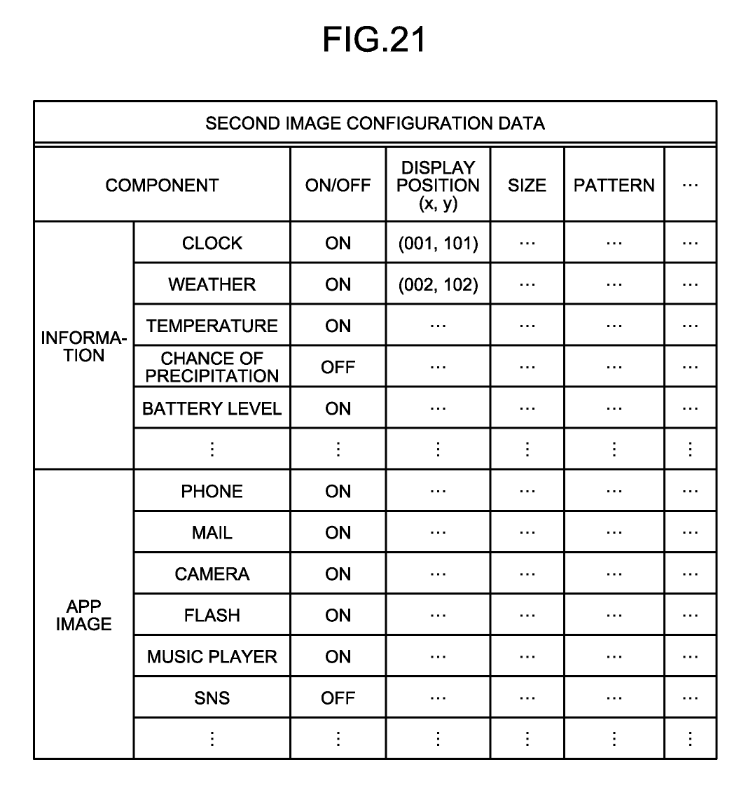

FIG. 21 is a diagram illustrating an example of the second image configuration data according to embodiments. As illustrated in FIG. 21, the second image configuration data is configured such that image components are each associated with, for example, information indicating the presence/absence of display of the component (ON/OFF), the display position of the component, the display size of the component, and the display pattern that is the design of the component. Examples of the image components include, but are not limited to, information and app images. Examples of the information include information of clock, weather, temperature, chance of precipitation, and battery level, as illustrated in FIG. 21. Examples of the app images include images depicting phone, mail, camera, flash, music player, and social network service (SNS), as illustrated in FIG. 21. In the example illustrated in FIG. 21, it is set that information of clock, weather, temperature, and battery level and app images of phone, mail, camera, flash, and music player are displayed as the second image.

The controller 10 can integrally control the operation of the smartphone 1 to implement a variety of functions. The controller 10 includes a processor. Examples of the processor may include, but are not limited to, a central processing unit (CPU), a system-on-a-chip (SoC), a micro control unit (MCU), a field-programmable gate array (FPGA), a coprocessor, etc. Other components, such as the communication unit 6, may be incorporated into the SoC. The controller 10 is an example of the controller.

Specifically, the controller 10 executes instructions included in a program stored in the storage 9 while referring to data stored in the storage 9 as necessary. The controller 10 controls a functional module in accordance with data and instructions and thereby implement a variety of functions. Examples of the functional module include, but are not limited to, at least one of the first display 2A, the second display 2B, the communication unit 6, the microphone 8, and the speaker 11. The controller 10 may change control in accordance with a detection result of a detection module. Examples of the detection module include, but are not limited to, the touchscreen 2C, the keys 3, the ambient light sensor 4, the proximity sensor 5, the microphone 8, the camera 12, the camera 13, the motion sensor 15, etc.

The controller 10 executes the control program 9A to implement the process of: displaying the first image in a display region corresponding to the region 23a in the display region of the second display 2B when the first display 2A is in the display state; and displaying the second image in a display region corresponding to the region 23a in the display region of the second display 2B when the first display 2A is in the hidden state.

The speaker 11 can output a sound signal transmitted from the controller 10 as sound. The speaker 11 may output, for example, ringer and music. One of the receiver 7 and the speaker 11 may have the other's function.

The camera 12 and the camera 13 can convert a captured image into an electrical signal. The camera 12 may be an in-camera that captures an image of an object facing the first display 2A. The camera 13 may be an out-camera that captures an image of an object facing the face on the opposite side to the first display 2A. The camera 12 and the camera 13 may be mounted in the smartphone 1 in a functionally and physically integrated state as a camera unit that can be used in a switchable manner between the in-camera and the out-camera.

The connector 14 is a terminal to which any other device is connected. The connector 14 may be a general terminal, such as a universal serial bus (USB), a high-definition multimedia interface (HDMI) (registered trademark), Light Peak (Thunderbolt (registered trademark)), and a headset microphone connector. The connector 14 may be a dedicated terminal, such as a dock connector. Examples of the device connected to the connector 14 include, but are not limited to, an external storage, a speaker, a communication device, etc.

The motion sensor 15 can detect a variety of information for determining the operation of the user carrying the smartphone 1. The motion sensor 15 may be configured as a sensor unit including, for example, an acceleration sensor, a direction sensor, a gyro scope, a magnetic sensor, and a pressure sensor.

The smartphone 1 may include, in addition to the functional modules described above, a GPS receiver and a vibrator. The GPS receiver receives radio signals in a prescribed frequency band from GPS satellites. The GPS receiver demodulates the received radio signals and sends the demodulated signals to the controller 10. The GPS receiver supports the processing of computing the present position of the smartphone 1. The smartphone 1 may include a receiver capable of receiving signals of navigation satellites other than the GPS satellites to execute the processing of computing the present position. The vibrator vibrates part or the entire of the smartphone 1. The vibrator has, for example, a piezoelectric element or an eccentric motor for producing vibration. In addition to the GPS receiver and the vibrator, the smartphone 1 may be equipped with a functional module naturally used for maintaining the functions of the smartphone 1, such as a battery, and a controller naturally used for implementing the control of the smartphone 1.

The smartphone 1 may access a storage server on cloud through the communication unit 6 to acquire a variety of programs and data.

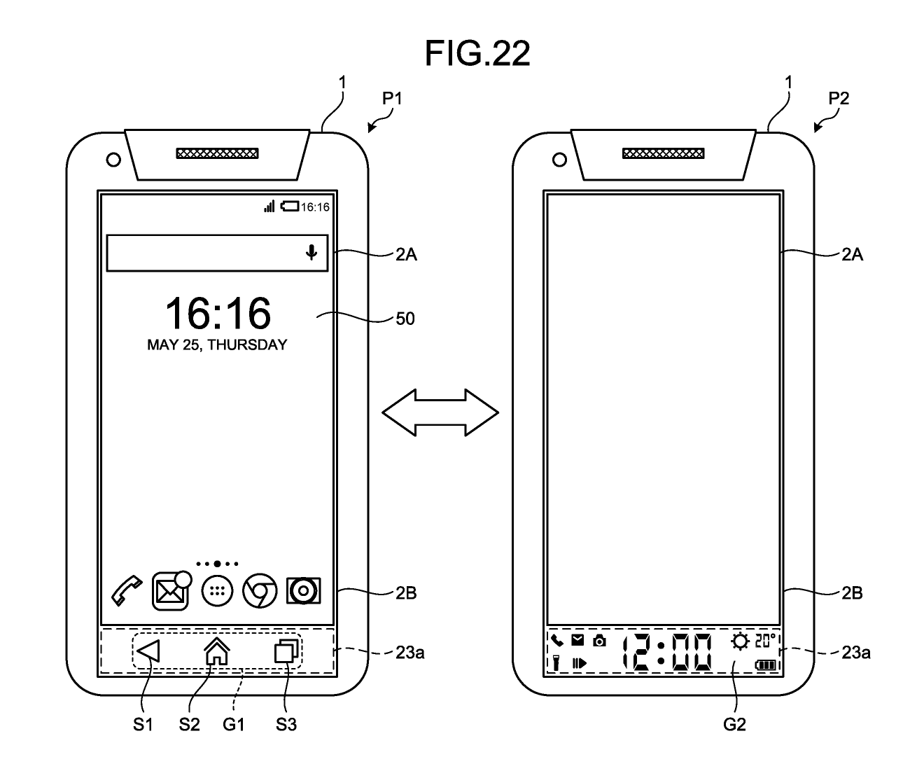

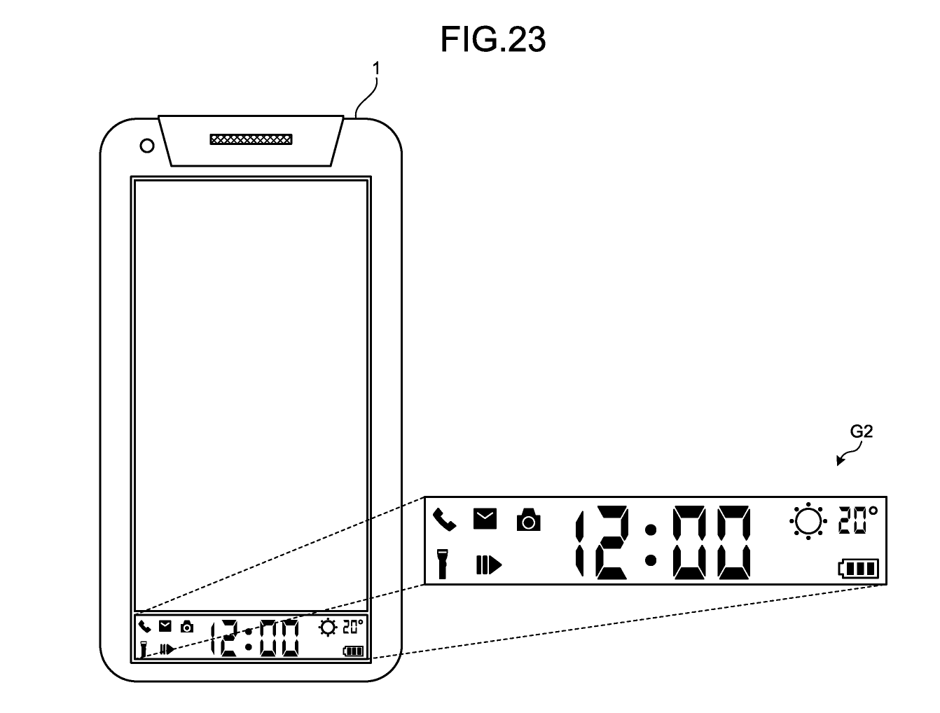

Referring to FIG. 22 and FIG. 23, a display method by the smartphone 1 according to embodiments will be described. FIG. 22 and FIG. 23 are diagrams illustrating an example of the display method by the smartphone according to embodiments.

As illustrated in P1 in FIG. 22, when the first display 2A is in the display state, the smartphone 1 displays a first image G1 in a display region corresponding to the region 23a in the display region of the second display 2B. The smartphone 1 switches a display region overlapping the first display 2A in the display region of the second display 2B to the transmissive state. For example, when a home screen 50 appears on the first display 2A, the smartphone 1 allows the second display 2B to display the first image G1 related to the home screen 50. In the example illustrated in P1 in FIG. 22, the first image G1 includes a return key symbol S1, a home key symbol S2, and a task key symbol S3 that form navigation keys.

On the other hand, as illustrated in P2 in FIG. 22, when the first display 2A is in the hidden state (not turned on), the smartphone 1 displays a second image G2 in a display region corresponding to the region 23a in the display region of the second display 2B. Here, the smartphone 1 may switch a display region overlapping the first display 2A in the display region of the second display 2B to the transmissive state or may display an image different from the second image G2. As illustrated in FIG. 23, the second image G2 is configured with information of clock, weather, temperature, and battery level and app images of phone, mail, camera, flash, and music player.

The smartphone 1 can automatically execute switching from display by the display method illustrated in P1 in FIG. 22 to display by the display method illustrated in P2 in FIG. 22 and switching from display by the display method illustrated in P2 in FIG. 22 to display by the display method illustrated in P1 in FIG. 22, depending on the display state of the first display 2A.

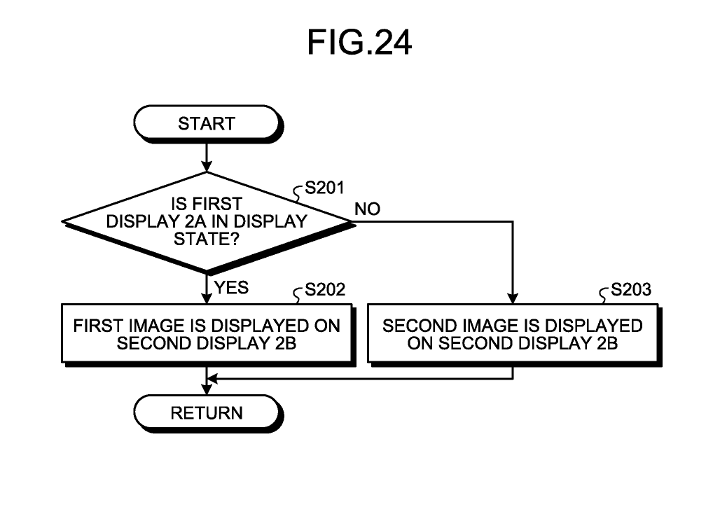

Referring to FIG. 24, an example of the process executed by the smartphone 1 will be described. FIG. 24 is a flowchart illustrating an example of the process executed by the smartphone according to embodiments. The process illustrated in FIG. 24 is implemented by the controller 10 executing the control program 9A. The process illustrated in FIG. 24 is repeatedly executed even in a mode in which power supply is partially controlled, that is, a power saving mode, as long as the smartphone 1 is in an operative state.

As illustrated in FIG. 24, the controller 10 determines whether the first display 2A is in the display state (Step S201).

If it is determined that the first display 2A is in the display state (Yes at Step S201), the controller 10 displays a first image on the second display 2B (Step S202) and returns to the determination at Step S201.

On the other hand, if it is determined that the first display 2A is not in the display state (No at Step S201), the controller 10 displays a second image on the second display 2B (Step S203) and returns to the determination at Step S201.

A described above, when the first display 2A is in the display state, the smartphone 1 displays a first image G1 configured with key symbols relevant to an image and the like appearing on the first display 2A, in a display region corresponding to the region 23a in the display region of the second display 2B. On the other hand, when the first display 2A is not in the display state (in the hidden state), the smartphone 1 displays the second image G2 configured with information and app images, in a display region corresponding to the region 23a in the display region of the second display 2B. In this way, according to embodiments, the convenience of the smartphone 1 can be improved by supplementarily utilizing the second display 2B according to the display situation of the first display 2A. The power consumption can also be reduced by utilizing the second display 2B, compared with when the entire display is executed by the liquid crystal display.

In the foregoing embodiments, when an operation on a navigation key that is a virtual key displayed as the first image G1 is detected, the smartphone 1 can execute the processing corresponding to the operated navigation key. In this way, the smartphone 1 can accept an operation input through a navigation key virtually configured. When an operation on an app image included in the second image G2 is detected, the smartphone 1 can execute the processing of the application corresponding to the app image. In this way, the smartphone 1 can provide the user predetermined information through the second image G2, for example, even in a sleep state and can also provide the user quick access to a desired application through the second image G2.

In the foregoing embodiments, the second display 2B may not be positioned to overlap in such a manner as to cover all of the first display 2A, the front panel 22, and the region 23a. For example, the second display 2B may be mounted in a size that can cover at least the region 23a.

Embodiments in a case where the smartphone 1 is equipped with a key physically configured on the outside of the display region of the first display 2A will be described.

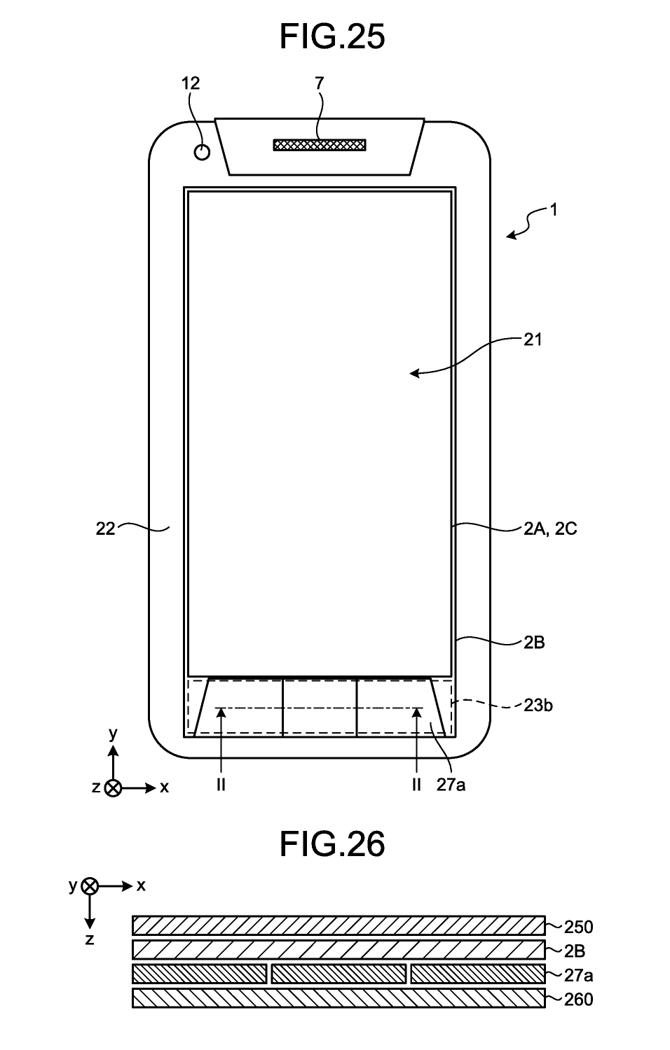

FIG. 25 is an example of a front view of the smartphone according to embodiments. As illustrated in FIG. 25, the smartphone 1 includes an operation key 27a physically configured in a region 23b of the front face 21. The operation key 27a is provided adjacent to the first display 2A in the y-axis direction at a position that does not overlap the first display 2A. The operation key 27a is configured, for example, in such a manner that three keys independent of each other are joined. The second display 2B may be positioned to overlap in such a manner as to cover all of the first display 2A, the front panel 22, and the operation key 27a. The region 23b is an example of the operation part.

FIG. 26 is a diagram schematically illustrating a cross section taken along line II-II in FIG. 25 according to embodiments. As illustrated in FIG. 26, the region 23b is configured such that the cover glass 250, the second display 2B, the operation key 27a, and the circuit board 260 are stacked in this order from the display plane of the smartphone 1 toward the positive direction of the Z axis. The cover glass 250, the second display 2B, the operation key 27a, and the circuit board 260 may be stacked, for example, in such a manner as to be laminated with photocurable resin, adhesive, or the like. Since the touchscreen 2C is not inserted in the region 23b, the smartphone 1 directly accepts the user's operation on the operation key 27a from on the cover glass 250 and the second display 2B.

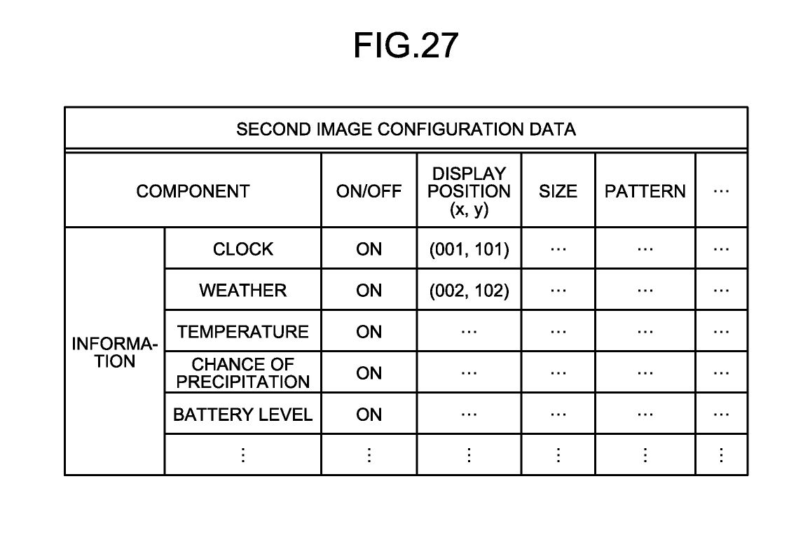

FIG. 27 is a diagram illustrating an example of the second configuration image data according to embodiments. As illustrated in FIG. 27, the second image configuration data includes information of clock, weather, temperature, chance of precipitation, and battery level, as image components.

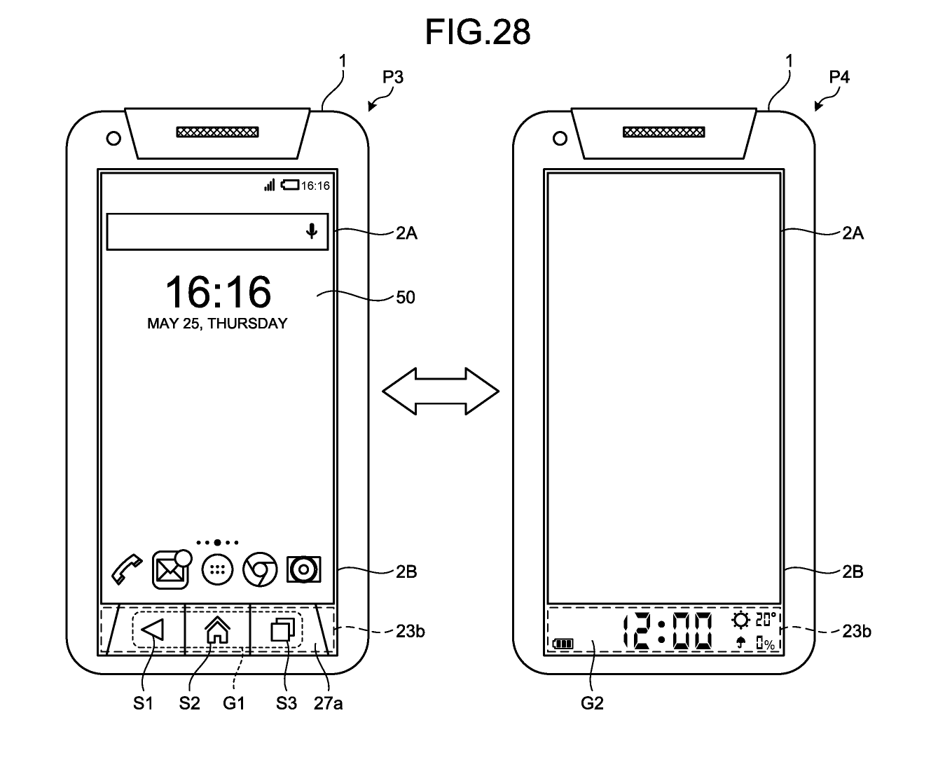

FIG. 28 is a diagram illustrating an example of the display method by the smartphone according to embodiments. As illustrated in P3 in FIG. 28, when the first display 2A is in the display state, the smartphone 1 displays the first image G1 in a display region corresponding to the region 23b in the display region of the second display 2B. The smartphone 1 displays the first image G1 in such a manner that the return key symbol S1, the home key symbol S2, and the task key symbol S3 are displayed immediately above the corresponding keys of the corresponding operation key 27a. The smartphone 1 may switch a display region overlapping the first display 2A in the display region of the second display 2B to the transmissive state.

On the other hand, as illustrated in P4 in FIG. 28, when the first display 2A is in the hidden state (not turned on), the smartphone 1 displays the second image G2 in a display region corresponding to the region 23b in the display region of the second display 2B. The second image G2 displayed in the region 23b is configured with information of clock, weather, temperature, chance of precipitation, and battery level. The smartphone 1 may switch the display region overlapping the first display 2A in the display region of the second display 2B to the transmissive state or may display an image different from the second image G2.

According to embodiments, when the first display 2A is in the display state, the key symbol corresponding to each function included in the navigation key used for operating an image and the like displayed on the first display 2A can be displayed on the operation key 27a using the second display 2B. This configuration can provide a use environment similar to the operation key initially marked with a key symbol. According to embodiments, when the first display 2A is in the hidden state, the second image G2 including various information can be displayed in a display region corresponding to the region 23a in the display region of the second display 2B. This configuration can provide the user information through the second display 2B even when the first display 2A is not displayed. In this way, according to a second embodiment, the convenience of the smartphone 1 can be improved.

The smartphone 1 can automatically execute switching from display by the display method illustrated in P3 in FIG. 28 to display by the display method illustrated in P4 in FIG. 28 and switching from display by the display method illustrated in P4 in FIG. 28 to display by the display method illustrated in P3 in FIG. 28, depending on the display state of the first display 2A.

A case where the smartphone 1 is initially equipped with virtual navigation keys or physical navigation keys will be described below.

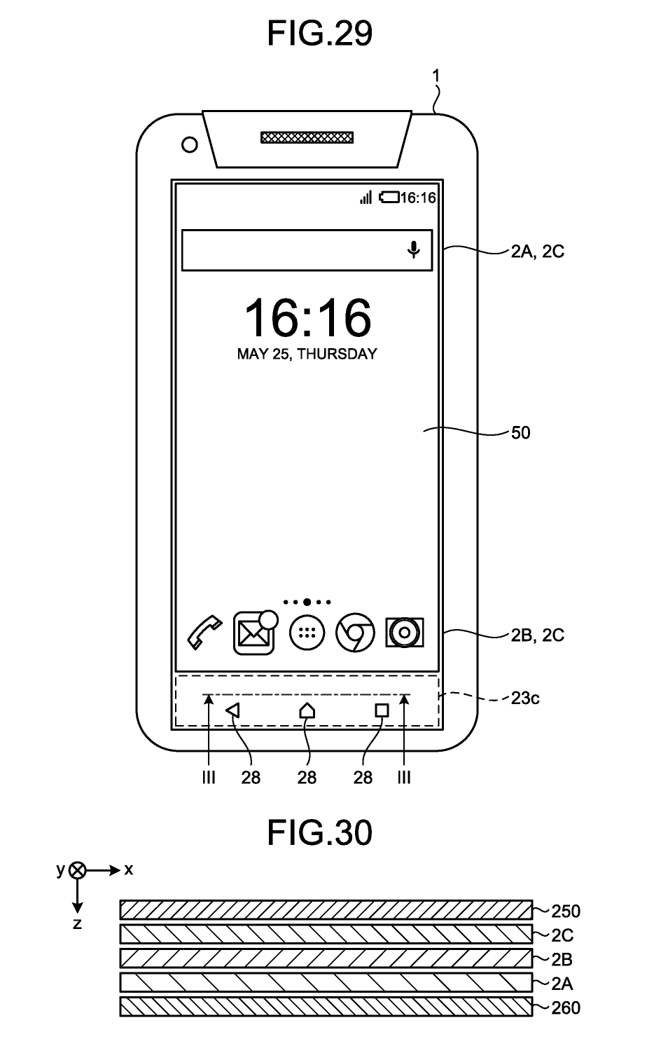

FIG. 29 is an example of a front view of the smartphone according to embodiments. In the example illustrated in FIG. 29, the smartphone 1 includes a region 23c in which virtual navigation keys 28 for operating the home screen 50 and the like appearing on the first display 2A are displayed. FIG. 30 is a schematic diagram illustrating a cross section taken along line III-III in FIG. 29 according to embodiments. As illustrated in FIG. 30, the region 23c is configured such that, for example, the cover glass 250, the touchscreen 2C, the second display 2B, the first display 2A, and the circuit board 260 are stacked in this order from the display plane of the smartphone 1 toward the positive direction of the Z axis. The region 23c is an example of the operation part.

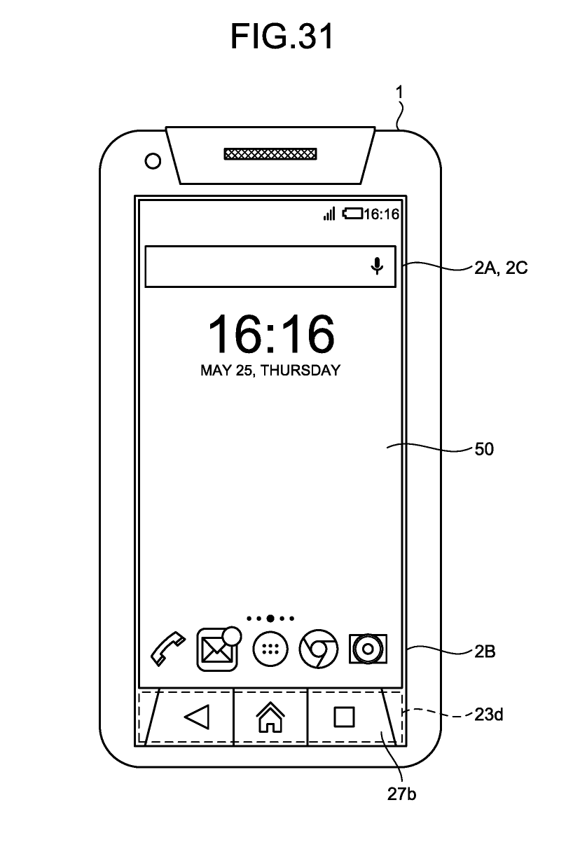

FIG. 31 is another example of the front view of the smartphone according to embodiments. In the example illustrated in FIG. 31, the smartphone 1 includes an operation key 27b physically configured, in a region 23d of the front face 21. The operation key 27b is marked with a key symbol that forms a navigation key to be used for operating, for example, the home screen 50 displayed on the first display 2A. The region 23d has a stacked structure similar to the region 23b illustrated in FIG. 25. The region 23d is an example of the operation part.

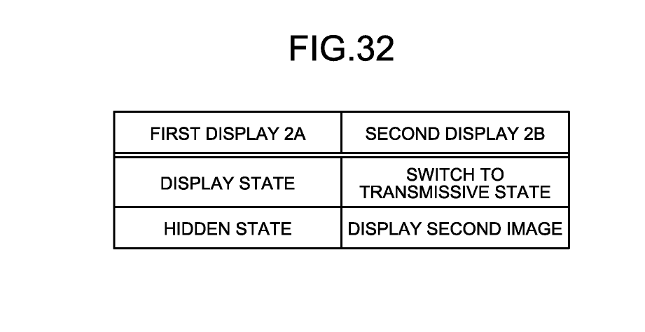

FIG. 32 is a diagram illustrating a configuration example of the display control table according to embodiments. The display control table 90B illustrated in FIG. 32 differs from other embodiments in setting value when the first display 2A is in the display state. That is, in the example illustrated in FIG. 32, it is set that the second display 2B is switched to the transmissive state when the first display 2A is in the display state, and it is set that the second image is displayed on the second display 2B when the first display 2A is in the hidden state.

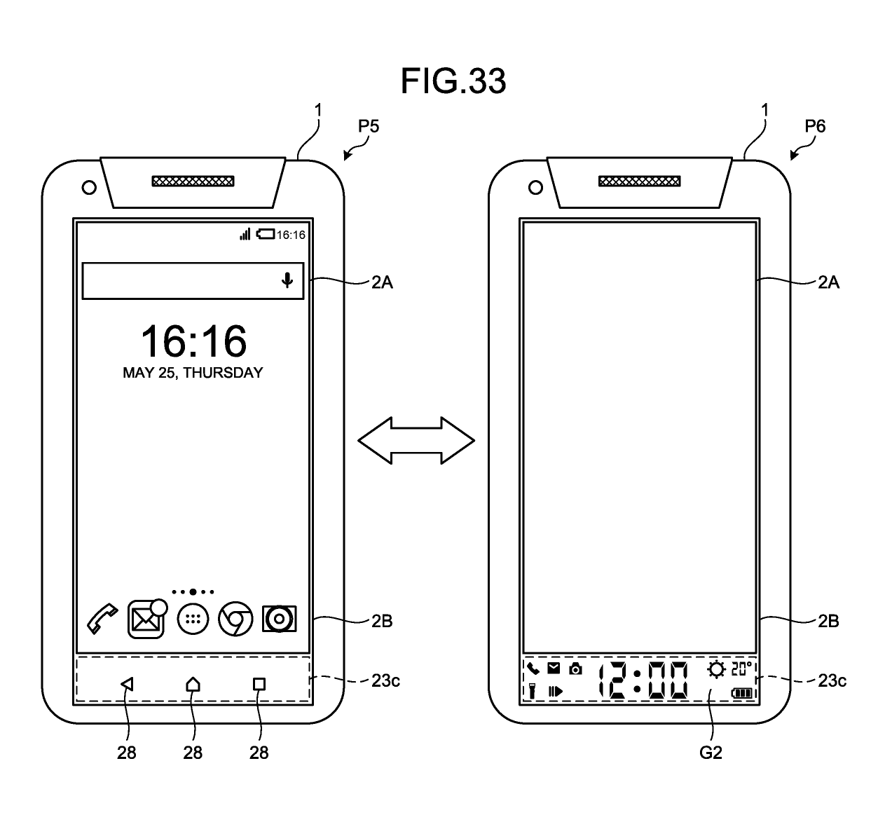

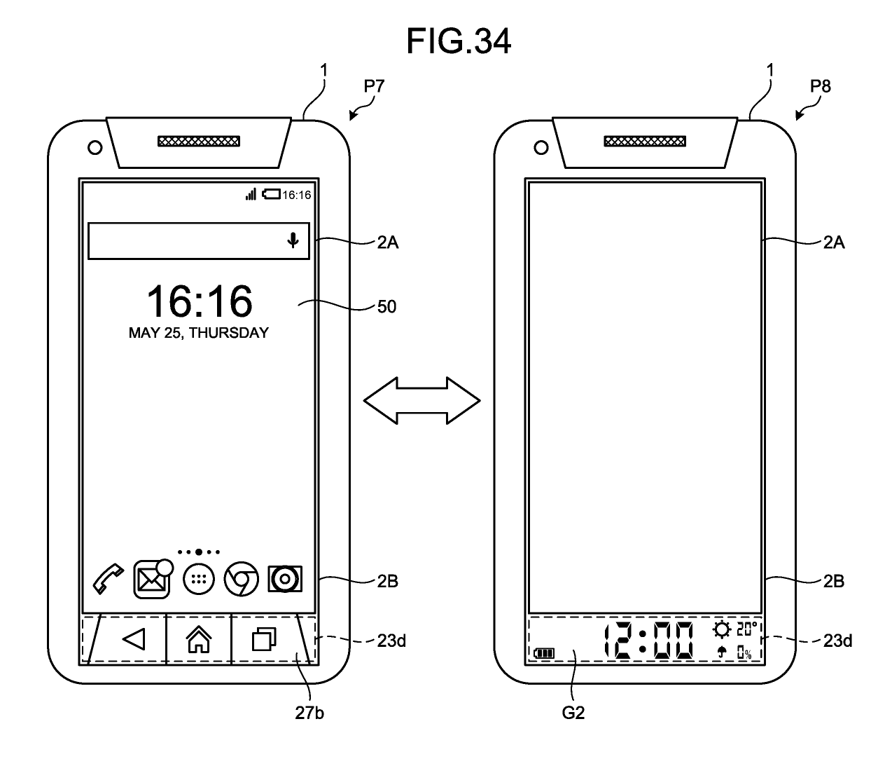

FIG. 33 and FIG. 34 are diagrams illustrating an example of the display method by the smartphone according to embodiments. The display method illustrated in FIG. 33 and FIG. 34 is executed in accordance with the display control table illustrated in FIG. 32.

Referring to FIG. 33, the display method in a case where the smartphone 1 is equipped with virtual navigation keys will be described. As illustrated in P5 in FIG. 33, when the first display 2A is in the display state, the smartphone 1 switches the second display 2B to the transmissive state. When the second display 2B is provided in such a manner as to cover the whole area of the first display 2A, the smartphone 1 switches the entire display region of the second display 2B to the transmissive state. The user thus can perform an operation while viewing navigation keys 28 behind the second display 2B through the region 23c.

On the other hand, as illustrated in P6 in FIG. 33, when the first display 2A is in the hidden state, the smartphone 1 displays a second image G2 in a display region corresponding to the region 23c in the display region of the second display 2B. Here, the smartphone 1 may switch the display region overlapping the first display 2A in the display region of the second display 2B to the transmissive state or may display an image different from the second image G2. As illustrated in P6 in FIG. 33, the second image G2 is configured with information of clock, weather, temperature, and battery level and app images of phone, mail, camera, flash, and music player.

The smartphone 1 can automatically execute switching from display by the display method illustrated in P5 in FIG. 33 to display by the display method illustrated in P6 in FIG. 33 and switching from display by the display method illustrated in P6 in FIG. 33 to display by the display method illustrated in P5 in FIG. 33, depending on the display state of the first display 2A.

Referring to FIG. 34, the display method in a case where the smartphone 1 is equipped with the operation key 27b marked with a key symbol corresponding to the navigation key will be described. As illustrated in P7 in FIG. 34, when the first display 2A is in the display state, the smartphone 1 switches the second display 2B to the transmissive state. When the second display 2B is provided in such a manner as to cover the whole area of the first display 2A, the smartphone 1 switches the entire display region of the second display 2B to the transmissive state. The user thus can perform an operation while viewing the operation key 27b behind the first display 2B through the region 23d. Since the touchscreen 2C is not inserted in the region 23d in the same manner as in the case illustrated in FIG. 26, the smartphone 1 can directly accept the user's operation on the operation key 27b from on the cover glass 250 and the second display 2B.

On the other hand, as illustrated in P8 in FIG. 34, when the first display 2A is in the hidden state (not turned on), the second image G2 is displayed in a display region corresponding to the region 23d in the display region of the second display 2B. The second image G2 displayed in the region 23d is configured with information of clock, weather, temperature, chance of precipitation, and battery level. The smartphone 1 may switch the display region overlapping the first display 2A in the display region of the second display 2B to the transmissive state or may display an image different from the second image G2.

The smartphone 1 can automatically execute switching from display by the display method illustrated in P7 in FIG. 34 to display by the display method illustrated in P8 in FIG. 34 and switching from display by the display method illustrated in P8 in FIG. 34 to display by the display method illustrated in P7 in FIG. 34, depending on the display state of the first display 2A.

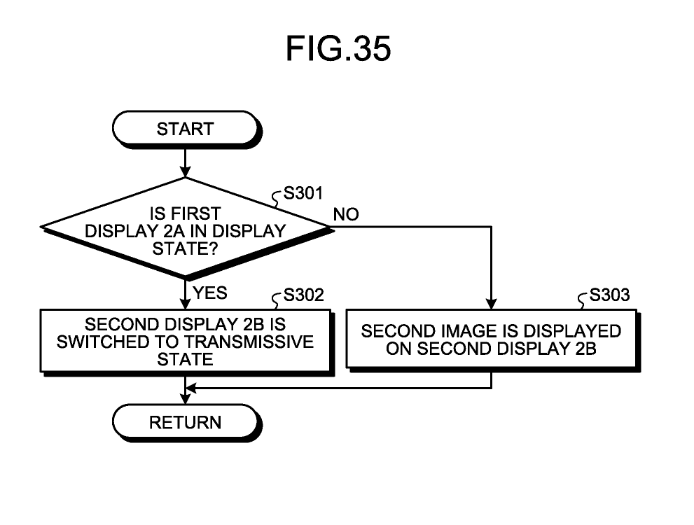

Referring to FIG. 35, an example of the process executed by the smartphone 1 will be described. FIG. 35 is a flowchart illustrating an example of the process executed by the smartphone according to embodiments. The process illustrated in FIG. 35 is implemented by the controller 10 executing the control program 9A. The process illustrated in FIG. 35 is repeatedly executed even in a mode in which power supply is partially controlled, that is, a power saving mode, as long as the smartphone 1 is in an operative state. The process illustrated in FIG. 35 differs from the process illustrated in FIG. 24 in the procedure at Step S302.

As illustrated in FIG. 35, the controller 10 determines whether the first display 2A is in the display state (Step S301).

If it is determined that the first display 2A is in the display state (Yes at Step S301), the controller 10 switches the second display 2B to the transmissive state (Step S302) and returns to the determination at Step S301.

On the other hand, if it is determined that the first display 2A is not in the display state (No at Step S301), the controller 10 displays the second image on the second display 2B (Step S303) and returns to the determination at Step S301.

According to embodiments, the convenience of the smartphone 1 can be improved also when the smartphone 1 is initially equipped with a virtual navigation key or a physical navigation key.

The characteristic embodiments have been described in order to fully and clearly disclose the techniques according to the appended claims. However, the appended claims are not limited to the foregoing embodiments and should be embodied by all modifications and alternative configurations that can be created by those skilled in the art within the scope of basic matters disclosed in the present description.

In the embodiments described above, the second display 2B is a polymer network liquid crystal display. However, the embodiments are not limited thereto, and the second display 2B may be electronic paper.

Conventional mobile electronic devices may have room for improvement in techniques for increasing the variety of displays appearing on the display.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A mobile electronic device comprising:
a first display;
a second display configured to switch between a transmissive state in which incident light is transmitted and a reflective state in which incident light is reflected; and
a controller configured to
when a predetermined event occurs while display is appearing on the first display, allow the second display to display a first image related to the predetermined event until a predetermined operation is detected after the predetermined event occurs, and
allow the second display to display a second image not related to occurrence of the predetermined event and then hide the second image after a predetermined time elapses.

2. The mobile electronic device according to claim 1, wherein
the first display is provided on one face of a housing, and
the second display is provided on an opposite face of the housing opposed to the one face.

3. The mobile electronic device according to claim 1, further comprising a light-transmitting colored member superimposed on the second display.

4. A mobile electronic device comprising:
a display configured to switch between a transmissive state in which incident light is transmitted and a reflective state in which incident light is reflected; and
a controller configured to
allow the display to display a first image related to a predetermined event until a predetermined operation is detected after the predetermined event occurs and
allow the display to display a second image not related to occurrence of the predetermined event and then hide the second image after a predetermined time elapses.

5. A mobile electronic device comprising:
a first display;
an operation part disposed at a position not overlapping at least the first display; and
a second display having a display region overlapping at least the operation part, the second display being configured to switch between a transmissive state in which incident light is transmitted and a reflective state in which incident light is reflected.

6. The mobile electronic device according to claim 5, further comprising a controller configured to
when the first display is in a display state, allow the second display to display a first image in a display region overlapping the operation part, and
when the first display is in a hidden state, allow the second display to display a second image in the display region overlapping the operation part.

7. The mobile electronic device according to claim 6, wherein the first image includes information related to the operation part.

8. The mobile electronic device according to claim 5, further comprising a controller configured to
when the first display is in a hidden state, allow the second display to display a predetermined image in a display region overlapping the operation part, and
when the first display is in a display state, switch the second display to the transmissive state.
